(19) United States
(12) Patent Application Publication
(10) Pub. No.: US 2004/0042398 A1
(43) Pub. Date: Mar. 4, 2004

(54) Method and apparatus for reducing traffic congestion by preventing allocation of the occupied portion of the link capacity and for protecting a switch from congestion by preventing allocation on some of its links

(75) Inventors: David Peleg, Rehovot (IL); Raphael Ben-Ami, Hertzelia (IL)

Correspondence Address: LADAS & PARRY, 26 WEST 61ST STREET, NEW YORK, NY, 10023, US

(73) Assignee: SERIQA NETWORKS

(21) Appl. No.: 10/377,155

(22) Filed: Feb. 27, 2003

Related U.S. Application Data
(60) Provisional application No. 60/360,960, filed on Feb. 28, 2002.

(51) Int. Cl. H04J 3/14; H04L 1/00

(52) U.S. Cl. 370/230; 370/235

(57) ABSTRACT

A traffic engineering method for reducing congestion and including estimating traffic over at least one link, having a defined capacity, between communication network nodes, thereby to determine an occupied portion of the link capacity and a complementary unoccupied portion of the link capacity, and based on the estimating step, selectably preventing allocation of the occupied portion of the link capacity to at least one capacity requesting client. Also, a method for reducing congestion in a communication network including at least one switch connected to a plurality of links, each having a defined physical capacity including a portion thereof which includes currently unutilized capacity, the method including computing an expected traffic load parameter over at least one switch, and based on the computing step, restricting allocation of at least a portion of at least one link's capacity if the expected traffic load parameter exceeds a threshold.

### FIELD OF THE INVENTION

The present invention relates to apparatus and methods for reducing traffic congestion.

### BACKGROUND OF THE INVENTION

The state of the art in traffic congestion reduction is believed to be represented by the following:

U.S. Pat. No. 6,301,257;

A. Tannenbaum, Computer Networks, 1981, Prentice Hall.

D. Bertsekas and R. Gallager, Data Networks, 1987, Prantice Hall.

Eric Osborne and Ajay Simha, Traffic Engineering with MPLS, Pearson, 2002.

Wideband and broadband digital cross-connect systems—generic criteria, Bellcore, publication TR-NWT-000233, Issue 3, November 1993.

ATM functionality in SONET digital cross-connect systems—generic criteria, Bellcore, Generic Requirements CR-2891-CORE, Issue 1, August 1995.

John T. Moy, OSPF: Anatomy of an internet routing protocol, Addison-Wesley, 1998.

C. Li, A. Raha, and W. Zaho, Stability in ATM Networks, Proc IEEE INFOCOM, September 1997.

A. G. Fraser, Towards a Universal Data Transport System, IEEE J. Selected Areas in Commun., SAC--1, No 5, (November 1983), pp 803-816.

Network Engineering and Design System Feature Description for MainStreetXpress ATM switches, Newbridge Network Corporation, March 1998.

Cisco express forwarding, In page http://www.cisco.com/univercd/cc/td/doc/product/software/ios112/ios112p/gsr/cef.htm.

Atsushi Iwata and Norihito Fujita, Crankback Routing Extensions for CR-LDP, Network Working Group, Internet Draft, NEC Corporation, July 2000.

[Awduche+02] D. O. Awduche, A. Chiu, A. Elwalid, I. Widjaja and X. Xiao, Overview and Principles of Internet Traffic Engineering, Internet draft IETF, January 02, draft-ietf-tewg-principles 02.txt.

ITU-T Recommendation Y.1231, Internet protocol aspects—Architecture, access,network capabilities and resource management, IP Access Network Architecture, 2001.

ITU-T Recommendation E.651, Reference Connections for Traffic Engineering of IP Access Networks, 2000.

ITU-T Recommendation I.371: Traffic Control and Congestion Control in B-ISDN, 2001.

ITU-T Recommendation Y.1241: IP Transfer Capability for Support of IP based Services, 2001.

ITU-T Recommendation Y.1311.1: Network Based IP VPN over MPLS Architecture, 2002.

ITU-T Recommendation Y.1311: IP VPNs—Generic Architecture and Service Requirements, 2001

ITU Draft Recommendation Y.iptc: Traffic Control and Congestion Control in IP Networks, July 2000

ITU-T Recommendation Y.1540: Formerly I.380, Internet Protocol Communication Service—IP packet transfer and availability performance parameters, 1999

ITU-T Recommendation Y.1541: Formerly I.381, Internet Protocol Communication Service—IP Performance and Availability Objectives and Allocations, 2002

IETF RFC 2680: A One-way Packet Loss Metric for IPPM, 1999.

IETF RFC 2702 Requirements for Traffic Engineering over MPLS, 1999.

IETF RFE 3201 RSVP-TE: Extensions to RSVP for LSP Tunnels, 2001

IETF RFC 2205 Resource ReSerVation Protocol (RSVP), Functional Specification, 1997.

IETF RFC 2211: Specification of the Controlled-Load Network, 1997.

IETF RFC 3209 Extensions to RSVP for LSP Tunnels, 2001.

IETF RFC 3210: Extensions to RSVP for LSP-Tunnels, 2001.

IETF RFE 2210: The Use of RSVP with IETF Integrated Services, 1999

IETF RFC 1633: Integrated Services in the Internet Architecture: an Overview, 1994.

IETF RFC 2210: The Use of RSVP with IETF Integrated Services, 1997.

IETF RFC 2211: Specification of the Controlled-Load Network Element Service, 1997

IETF RFC 2212: Specification of Guaranteed Quality of Services, 1997.

IETF RFC 2475: An Architecture for Differentiated Services, 1998.

IETF RFC 3031: Multiprotocol Label Switching Architecture, 2001.

IETF RFC 3032: MPLS label stack encoding, Category: Standards Track, 2001.

IETF draft draft-ietf-mpls-recovery-frmwrk-01.txt Framework for MPLS-based recovery, Category: Informative, 2001.

IETF RFC 2764: A Framework for IP Based Virtual Private Networks”, 2000.

IETF RFC 2547: BGP/MPLS VPNs”, 1999.

IETF RFC 2917: Malis, A., A Core MPLS IP VPN Architecture”, 2000

IETF RFC-1771: A Border Gateway Protocol 4 (BGP-4), 1995.

IETF RFC 3035: MPLS using LDP and ATM VC Switching, 2001.

IETF RFC 3034: Use of Label Switching on Frame Relay Networks Specification”, 2001.

IETF RFC 3036: LDP Specification, 2001.

IETF RFC 2983: Differentiated Services and Tunnels, 2000.

The disclosures of all publications mentioned in the specification and of the publications cited therein are hereby incorporated by reference.

### SUMMARY OF THE INVENTION

The present invention seeks to provide improved apparatus and methods for reducing traffic congestion.

There is thus provided, in accordance with a preferred embodiment of the present invention, a traffic engineering method for reducing congestion and including estimating traffic over at least one link, having a defined capacity, between communication network nodes, thereby to determine an occupied portion of the link capacity and a complementary unoccupied portion of the link capacity, and based on the estimating step, selectably preventing allocation of the occupied portion of the link capacity to at least one capacity requesting client.

Further in accordance with a preferred embodiment of the present invention, each link has a defined physical capacity and each link is associated with a list of clients and, for each client, an indication of the slice of the link's capacity allocated thereto, thereby to define a reserved portion of the link's capacity including a sum of all capacity slices of the link allocated to clients in the list of clients.

Still further in accordance with a preferred embodiment of the present invention, preventing allocation includes partitioning the occupied portion of the link into at least consumed unreservable capacity and reserved capacity and preventing allocation of the consumed unreservable capacity to at least one requesting client.

Still further in accordance with a preferred embodiment of the present invention, each link is associated with a list of clients and the step of partitioning includes adding a fictitious client to the list of clients and indicating that the portion of the link capacity allocated thereto includes the difference between the occupied portion of the link capacity and the reserved portion of the link capacity.

Still further in accordance with a preferred embodiment of the present invention, the step of adding is performed only when the difference is positive.

Further in accordance with a preferred embodiment of the present invention, the step of estimating traffic includes directly measuring the traffic.

Still further in accordance with a preferred embodiment of the present invention, the step of partitioning includes redefining the link capacity to reflect only capacity reserved to existing clients and the capacity of the unoccupied portion of the link.

Further in accordance with a preferred embodiment of the present invention, the estimating and preventing steps are performed periodically.

Also provided, in accordance with another preferred embodiment of the present invention, is a traffic engineering method for reducing congestion in a communication network including at least one switch connected to a plurality of links, each link having a defined physical capacity including a portion thereof which includes currently unutilized capacity, the method including computing an expected traffic load parameter over at least one switch, and based on the computing step, restricting allocation of at least a portion of the capacity of at least one of the links if the expected traffic load parameter exceeds a threshold.

Further in accordance with a preferred embodiment of the present invention, the step of computing expected traffic load parameter includes estimating the current traffic over at least one switch interconnecting communication network nodes.

Still further in accordance with a preferred embodiment of the present invention, the step of estimating traffic includes directly measuring the traffic load over the switch.

Still further in accordance with a preferred embodiment of the present invention, the step of estimating traffic includes measuring an indication of traffic over the switch.

Further in accordance with a preferred embodiment of the present invention, the indication of traffic includes packet loss over the switch.

Still further in accordance with a preferred embodiment of the present invention, the indication of traffic includes packet delay over the switch.

Further in accordance with a preferred embodiment of the present invention, the computing step includes computing an expected traffic load parameter separately for each link connected to the switch.

Still further in accordance with a preferred embodiment of the present invention, the method includes estimating traffic load parameter over at least one link between communication network nodes, thereby to determine an occupied portion of the link capacity and a complementary unoccupied portion of the link capacity, and, based on the evaluating step, preventing allocation of the occupied portion of the link capacity to at least one capacity requesting client.

Further in accordance with a preferred embodiment of the present invention, the method includes storing a partitioning of the defined capacity of each link into reserved capacity, consumed unreservable capacity, precaution-motivated unreservable capacity, and reservable capacity.

Further in accordance with a preferred embodiment of the present invention, the restricting step includes computing a desired protection level for the at least one switch, thereby to define a desired amount of precaution motivated unreservable capacity to be provided on the switch.

Further in accordance with a preferred embodiment of the present invention, the method also includes providing the desired switch protection level by selecting a desired protection level for each link connected to the at least one switch such that the percentage of each link's currently unutilized capacity which is reservable is uniform over all links.

Still further in accordance with a preferred embodiment of the present invention, the method also includes providing the desired switch protection level by assigning a uniform protection level for all links connected to the at least one switch, the uniform protection level being equal to the desired switch protection level.

Still further in accordance with a preferred embodiment of the present invention, the method also includes providing the desired switch protection level by computing precaution motivated unreservable capacities for each link connected to the at least one switch to provide equal amounts of free capacity for each link within at least a subset of the links connected to the at least one switch.

Further in accordance with a preferred embodiment of the present invention, restricting is performed periodically.

Still further in accordance with a preferred embodiment of the present invention, restricting allocation includes marking the portion of the capacity of at least one of the links as precaution motivated unreservable capacity.

Additionally in accordance with a preferred embodiment of the present invention, the step of preventing allocation includes marking the occupied portion of the link capacity as consumed unreservable capacity.

Also provided, in accordance with another preferred embodiment of the present invention, is a traffic engineering system for reducing congestion, the system including a client reservation protocol operative to compare, for each of a plurality of links connected to at least one switch, an indication of the physical capacity of each link to an indication of the sum of capacities of reserved slices of the link, and to allocate a multiplicity of capacity slices to a multiplicity of clients such that for each link, the indication of the sum of capacities of reserved slices does not exceed the indication of the physical capacity, and a capacity indication modifier operative to alter at least one of the following indications: an indication of the physical capacity of at least one link, and an indication of the sum of capacities of reserved slices for at least one link, to take into account at least one of the following considerations: for at least one link, an expected discrepancy between the link's actual utilized capacity and the sum of capacities of reserved slices for that link, for at least one switch, an expected discrepancy between the sum of actual utilized capacities over all links connected to an individual switch, and the capacity of the switch, thereby to reduce congestion.

Further in accordance with a preferred embodiment of the present invention, the method also includes providing the desired switch protection level by selecting a desired protection level for each link connected to the at least one switch including turning more of a link's currently unutilized capacity into precaution motivated unreservable capacity for a link having a relatively high unutilized capacity, relative to a link having a relatively low unutilized capacity.

Still further in accordance with a preferred embodiment of the present invention, the method also includes providing the desired protection level by selecting a desired protection level for each link connected to the at least one switch such that the desired amount of precaution motivated unreservable capacity on the switch is distributed equally among all of the links connected to the switch.

Further in accordance with a preferred embodiment of the present invention, the method also includes providing the desired switch protection level by computing precaution motivated unreservable capacities for each link connected to the at least one switch to provide equal amounts of free capacity for all links connected to the at least one switch.

Still further in accordance with a preferred embodiment of the present invention, the restricting step includes restricting allocation of at least a first portion of the capacity of at least one of the links if the expected traffic load parameter exceeds a first threshold, and restricting allocation of at least an additional second portion of the capacity of at least one of the links if the expected traffic load parameter exceeds a second threshold which is greater than the first threshold, wherein the additional second portion is greater than the first portion.

Also provided, in accordance with another preferred embodiment of the present invention, is a traffic engineering method for reducing congestion, the method including comparing, for each of a plurality of links connected to at least one switch, an indication of the physical capacity of each link to an indication of the sum of capacities of reserved slices of the link, and to allocate a multiplicity of capacity slices to a multiplicity of clients such that for each link, the indication of the sum of capacities of reserved slices does not exceed the indication of the physical capacity, and altering at least one of the following indications: an indication of the physical capacity of at least one link, and an indication of the sum of capacities of reserved slices for at least one link, to take into account at least one of the following considerations: for at least one link, an expected discrepancy between the link's actual utilized capacity and the sum of capacities of reserved slices for that link, for at least one switch, an expected discrepancy between the sum of actual utilized capacities over all links connected to an individual switch, and the capacity of the switch, thereby to reduce congestion.

Also provided, in accordance with another preferred embodiment of the present invention, is a traffic engineering system for reducing congestion and including a traffic estimator estimating traffic over at least one link, having a defined capacity, between communication network nodes, thereby to determine an occupied portion of the link capacity and a complementary unoccupied portion of the link capacity, and an allocation controller operative, based on output received from the traffic estimator, to selectably prevent allocation of the occupied portion of the link capacity to at least one capacity requesting client.

Also provided, in accordance with a preferred embodiment of the present invention, is a traffic engineering system for reducing congestion in a communication network including at least one switch connected to a plurality of links, each link having a defined physical capacity including a portion thereof which includes currently unutilized capacity, the system including a traffic load computer operative to compute an expected traffic load parameter over at least one switch, and an allocation restrictor operative, based on an output received from the traffic load computer, to restrict allocation of at least a portion of the capacity of at least one of the links if the expected traffic load parameter exceeds a threshold.

The present specification and claims employ the following terminology:

Physical link capacity=the maximum amount of traffic which a particular link can support within a given time period.

Physical switch capacity=the sum of the physical capacities of all links connected to the switch.

Reserved capacity=a portion of physical capacity which is allocated to paying clients.

Unreservable capacity=a portion of physical capacity which, e.g. because it has been locked or has been reserved to a fictitious client, cannot be allocated to paying clients typically because it has been found to be in use (consumed) or as a preventative measure to avoid future congestion in its vicinity (precaution-motivated).

Consumed unreservable capacity=a portion of unreservable capacity which cannot be allocated to paying clients because it has been found to be in use.

Precaution-motivated unreservable capacity=a portion of unreservable capacity which cannot be allocated to paying clients as a preventative measure to avoid future congestion in its vicinity.

Locked unreservable capacity=unreservable capacity whose unreservability is implemented by locking.

Fictitiously registered unreservable capacity=unreservable capacity whose unreservability is implemented by reservation of capacity on behalf of a fictitious client.

Reservable capacity=free capacity=capacity which is free to reserve or lock.

Utilized (or “occupied”) capacity=reserved capacity+consumed unreservable capacity.

Traffic=a raw measurement of actual flow of packets over links and through switches during a given time period.

Link's traffic load parameter an estimated rate of flow of traffic on a link, determined from raw traffic measurements, e.g. by averaging, or by external knowledge concerning expected traffic. Preferably, the traffic load parameter is between zero and the physical capacity of the link.

Unutilized capacity of a link=the total physical capacity of the link minus the link's traffic load parameter.

Switch's traffic load parameter=sum of traffic load parameters of all of the links connected to the switch.

Load ratio=The proportion of the switch's physical capacity which is utilized, i.e. the switch's traffic load parameter divided by the switch's physical capacity.

Link Protection level=percentage of the link's physical capacity which comprises precaution-motivated unreservable capacity.

Switch Protection level=percentage of the switch's physical capacity which comprises precaution-motivated unreservable capacity, e.g. the proportion of a switch's physical capacity which is locked to prevent it being allocated. Typically, the switch protection level is defined as an increasing function of the switch's load ratio.

Preliminary load threshold=the load ratio below which no protection of the switch is necessary. In accordance with a preferred embodiment of the present invention, as described below, a portion of the unutilized capacity of the switch's links is defined to be unreservable once the load of the switch exceeds the switch's preliminary load threshold.

Critical load threshold=the load ratio beyond which the switch is deemed overloaded because it is expected to perform poorly e.g. to lose packets. In accordance with a preferred embodiment of the present invention, as described below, the entirety of the unutilized capacity of the switch's links is defined to be unreservable and is termed “precaution motivated unreservable capacity” once the load of the switch exceeds the switch's critical load threshold.

A communication network typically comprises a collection of sites in which each site is connected to the other sites via communication switches or routers and the routers are interconnected by a collection of links of arbitrary topology. In the present specification and claims, the links are bidirectional, however it is appreciated that alternatively, an embodiment of the present invention may be developed for unidirectional links. Each link has a certain capacity associated with it, bounding the maximum amount of traffic that can be transmitted on it per time unit. The router can typically mark a portion of the physical capacity of each link as locked capacity. In IP networks this does not affect traffic, i.e., the locked capacity will still allow traffic to go over it. Network designers sometimes fix the locked capacity parameter permanently, typically in a uniform way over all the links in the entire network.

In various networking environments, a client may request to establish a connection to another client with some specified bandwidth. To support this request, the router at the requesting client should establish a route for the connection. The path for the new connection is typically selected by a routing algorithm, whose responsibility it is to select a route with the necessary amount of guaranteed reserved bandwidth. This is typically carried out by searching for a usable path, e.g., a path composed entirely of links that have sufficient free capacity for carrying the traffic. This route may then be approved by the client reservation protocol, which may also reserve the bandwidth requested for this connection on each link along the route. The total bandwidth reserved on a link for currently active connections is referred to as the reserved capacity. The client reservation protocol will approve a new connection along a route going through a link only if the free capacity on this link, namely, the physical capacity which is currently neither locked nor reserved, meets or exceeds the bandwidth requirements of the new connection.

At any given moment, each link experiences a certain traffic. This traffic can be measured and quantified by the system. The measure used may be either the peak bit rate or the average bit rate, as well as any of a number of other options. For our purposes it is convenient to model the situation by combining the actual traffic parameters that are measured in the system into a single (periodically updated) unifying parameter, henceforth referred to as the traffic load parameter, representing the traffic over the link at any given time.

One objective of a preferred embodiment of the present invention is to serve applications in which the mechanisms for injecting traffic into the network are generally not constrained by capacity considerations. In particular, the policing at the traffic entry points, aimed to prevent a given connection from injecting traffic at a higher rate than its allocated bandwidth, is often costly or ineffective, as it only tracks average performance over reserved sessions. In addition, the network may carry substantial amounts of native (unreserved) IP traffic. Consequently, the traffic level and the reservation level over a link are hardly ever equal. This implies that the Reserved Capacity parameter is misleading, and relying on it for making decisions concerning future bandwidth allocations may lead to congestion situations. Moreover, various traffic-engineering methods that were developed to deal with congestion problems, such as MPLS-TE, are based on the assumption that traffic is organized in connections that obey their allocated bandwidths. Therefore, having unconstrained traffic in the network makes it difficult or ineffective to use these methods.

Another objective of a preferred embodiment of the present invention is to serve applications in which congestion may still occur even if traffic obeys the bandwidth restrictions imposed on it. This may occur because routers typically find it difficult to operate at traffic levels close to their maximum physical capacity. It is therefore desirable to maintain lower traffic levels on the routers, say, no more than 70% of the physical capacity. On the other hand, such limitations do not apply to the communication links. Therefore imposing a maximum traffic restriction uniformly on every component of the system typically does not utilize the links effectively. For example, suppose that two links are connected to a router. Restricting both links to 70% of their physical capacity is wasteful, since a link can operate at maximum capacity with no apparent performance degradation. Hence if one of the links is currently lightly loaded, it is possible to allocate traffic on the other link to its full capacity. This will not overload either that link or the router, because the total traffic on the router is still medium, due to the light load on the first link. Similarly, if later the second link becomes lighter, then it is possible to allocate traffic on the first link to full capacity. At all times, however, it is necessary to prevent the links from being loaded simultaneously, as this would overload the router. State of the art networks do not include technology for enforcing such a policy.

### BRIEF DESCRIPTION OF THE DRAWINGS

The present invention will be understood and appreciated from the following detailed description, taken in conjunction with the drawings and appendices in which:

FIG. 1 is a simplified flowchart illustration of a first traffic engineering method for reducing congestion, operative in accordance with a first preferred embodiment of the present invention, the method including estimating traffic over at least one link, having a defined capacity, between communication network nodes, thereby to determine an occupied portion of the link capacity and a complementary unoccupied portion of the link capacity and preventing allocation of the occupied portion of the link capacity to new clients;

FIG. 2A is a simplified flowchart illustration of a first preferred method for implementing step 130 of FIG. 1, in accordance with a first preferred embodiment of the present invention;

FIG. 2B is a simplified flowchart illustration of a second preferred method for implementing step 130 of FIG. 1, in accordance with a second preferred embodiment of the present invention;

FIG. 3A is an example of a switch with 3 associated links, for which the method of FIGS. 1-2B is useful in reducing congestion;

FIG. 3B is a timeline showing the operation of the method of FIG. 1, according to the implementation of FIG. 2A, on the switch of FIG. 3A, as a function of time;

FIG. 3C is a list of clients to whom slices of link capacity have been allocated as step 30 of cycle n begins;

FIGS. 4A-4G illustrate the contents of a table of computational results obtained by using the method of FIG. 1 in accordance with the implementation of FIG. 2A, at timepoints shown on the timeline of FIG. 3B, starting from the beginning of step 30 in cycle n and extending until the end of cycle n+1;

FIGS. 5A-5G illustrate the contents of a table of computational results obtained by using the method of FIG. 1 in accordance with the implementation of FIG. 2B, at timepoints shown on the timeline of FIG. 7, starting from the beginning of step 30 in cycle n and extending until the end of cycle n+1;

FIGS. 6A-6F is a list of clients to whom slices of link capacity have been allocated at various timepoints in the course of cycles n and n+1 during operation of the method of FIGS. 1 and 2B;

FIG. 7 is a timeline showing the operation of the method of FIG. 1, according to the implementation of FIG. 2B, on the switch 170 of FIG. 3A, as a function of time, including the timepoints associated with the tables of FIGS. 5A-5G and with the client lists of FIGS. 6A-6F;

FIG. 8 is a simplified flowchart illustration of a second traffic engineering method for reducing congestion in a communication network including at least one switch connected to a plurality of links, each link having a defined physical capacity, the method being operative in accordance with a second preferred embodiment of the present invention and including computing an expected traffic load parameter over each link connected to at least one switch and restricting allocation of at least a portion of the capacity of at least one of the links if the expected traffic load parameter exceeds a threshold.

FIG. 9 is a simplified flowchart illustration of a preferred implementation of step 330 in FIG. 8 and of step 1360 in FIG. 18;

FIG. 10A is a simplified flowchart illustration of a first preferred method for implementing step 450 of FIG. 9;

FIG. 10B is a simplified flowchart illustration of a second preferred method for implementing step 450 of FIG. 9;

FIG. 11 is a simplified flowchart illustration of a preferred implementation of switch protection level computing step 400 in FIG. 9;

FIG. 12 is a simplified self-explanatory flowchart illustration of a first alternative implementation of the desired protection level determination step 430 in FIG. 9;

FIG. 13 is a simplified self-explanatory flowchart illustration of a second alternative implementation of the desired protection level determination step 430 in FIG. 9;

FIG. 14 is a simplified self-explanatory flowchart illustration of a third alternative implementation of the desired protection level determination step 430 in FIG. 9;

FIG. 15 is an example of a switch with 4 associated links, for which the method of FIGS. 8-14 is useful in reducing congestion;

FIG. 16 is a table of computational results obtained by monitoring the switch of FIG. 15 and using the method of FIGS. 8-11, taking the switch's desired protection level as each link's desired protection level in step 430 of FIG. 9;

FIG. 17A is a table of computational results obtained by monitoring the switch of FIG. 15 using the method of FIGS. 8-11 and 12;

FIG. 17B is a table of computational results obtained by monitoring the switch of FIG. 15 using the method of FIGS. 8-11 and 13;

FIG. 17C is a table of computational results obtained by monitoring the switch of FIG. 19 using the method of FIGS. 8-11 and 14; and

FIG. 18 is a simplified flowchart illustration of a traffic engineering method which combines the features of the traffic engineering methods of FIGS. 1 and 8.

### DETAILED DESCRIPTION OF A PREFERRED EMBODIMENT

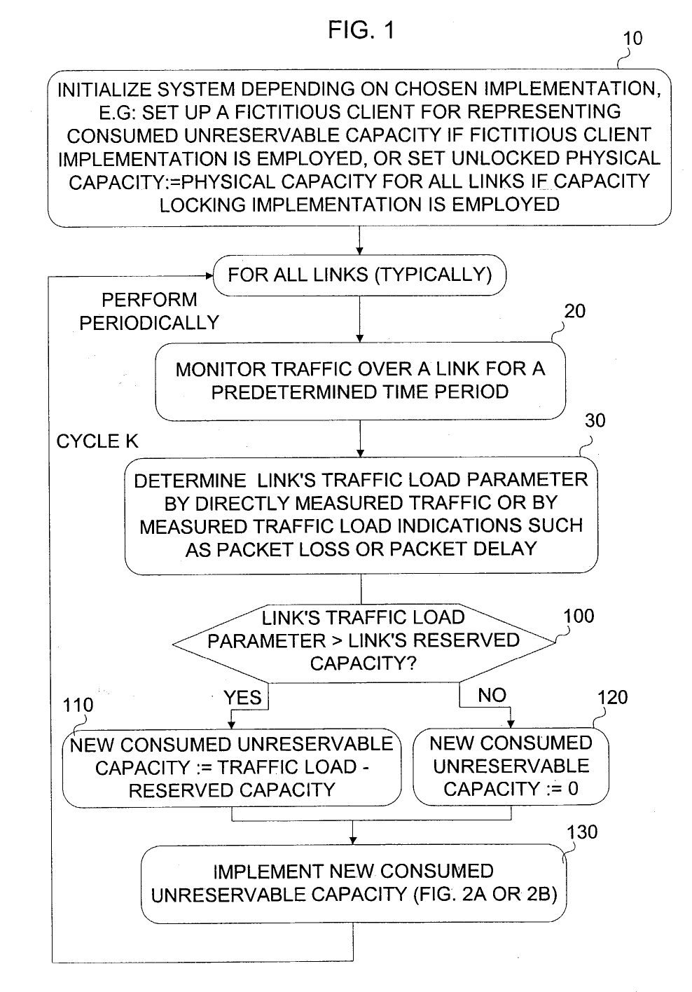

FIG. 1 is a simplified flowchart illustration of a first traffic engineering method for reducing congestion, operative in accordance with a first preferred embodiment of the present invention, to diminish the free capacity, by locking or by defining a fictitious client, as a function of the actual level of utilization of the network as opposed to the theoretical level of utilization implied by client reservations. The method of FIG. 1 preferably including estimating traffic over at least one link, having a defined physical capacity, between communication network nodes, thereby to determine an occupied portion of the link capacity and a complementary unoccupied portion of the link capacity and preventing allocation of the occupied portion of the link capacity to new clients.

FIG. 1, STEP 10: A data structure suitable for monitoring the traffic over each of at least one link and preferably all links in a network, is provided. The data structure typically comprises, for each switch and each link within each switch, a software structure for storing at least the following information: traffic samples taken while monitoring traffic over the relevant switch and link, variables for storing the computed traffic load parameters for each switch and link, variables for storing the reserved capacity, consumed unreservable capacity, precaution-motivated unreservable capacity and reservable capacity for each switch and link, and variables for storing intermediate values computed during the process.

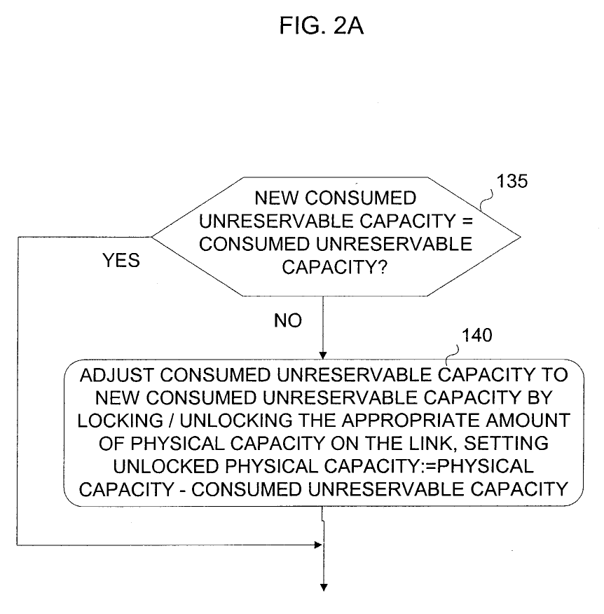

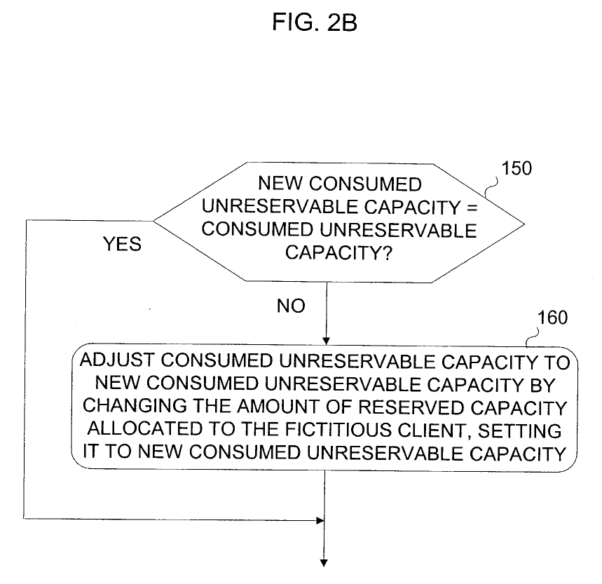

Conventional switches include a mechanism for registering clients. For example, in Cisco switches, clients are termed “sessions” and the mechanism for registering clients is the RSVP mechanism. If the “fictitious client” embodiment described herein with reference to FIG. 2B is employed, the setup step 10 typically includes setting up, for at least one link, a fictitious client by instructing the mechanism for registering clients to establish a fictitious client e.g. by reserving a certain minimal slice of capacity (bandwidth) therefor.

The steps in the method of FIG. 1 are now described in detail.

STEP 20: Monitoring the traffic can be done in a number of ways. For example, it is possible to sample the traffic at regular intervals and store the most recent k samples, for an appropriately chosen k. Conventional switches include a packet counter for each link which counts each packet as it goes over the relevant link. The term “sampling” typically refers to polling the link's packet counter in order to determine how many packets have gone over that link to date. Typically polling is performed periodically and the previous value is subtracted to obtain the number of packets that have gone over the link since the last sampling occurred. It is also possible to poll other traffic related parameters such as the delay over the link (i.e., the time it takes for a message to cross the link), the packet drop rate over the link, measuring the number of lost and/or dropped packets within the most recent time window, or the CPU utilization of the packet forwarding processor.

STEP 30: A traffic load parameter, falling within the range between 0 and the physical capacity of the link, is estimated for each time interval. The traffic load parameter is typically a scalar which characterizes the traffic during the time interval. Determining the traffic load parameter can be done in a number of ways.

For example, for each traffic related parameter sampled in step 20, it is possible to compute some statistical measure (such as the mean or any other central tendency) of the most recent k samples, for an appropriately chosen k, reflecting the characteristic behavior of the parameter over that time window. If averaging is performed, it may be appropriate to apply a nonlinear function to the measured values, giving higher weight to large values, and possibly assigning more significance to later measurements over earlier ones within the time window.

Each of these statistical measures is normalized to an appropriate scale, preferably to a single common scale in order to make the different statistical measures combinable. This can be done by defining the lower end of the scale, for each statistical measure, to reflect the expected behavior of that statistical measure when the system is handling light traffic, and defining the high end of the scale to reflect the expected behavior of that statistical measure when the system is handling heavy traffic. For example, if the traffic related parameter measured is the packet drop rate and the statistical measure is the mean, then the expected behavior of a switch in the system under light traffic may, for example, exhibit an average drop rate of 2 packets per million whereas the expected behavior of a switch in the system under heavy traffic may exhibit an average drop rate of, for example, 1,000 packets per million.

A combination, such as a weighted average, of these statistical measures may then be computed and this combination is regarded as quantifying the load status of the link. The combination function used to determine the final traffic load parameter from the statistical measures can be fixed initially by the system programmer or network designer offline, or tuned dynamically by an automatic self-adapting system.

For example, one suitable combination function may comprise a weighted average of the average traffic rate (weighted by 80%) and the packet drop rate (weighted by 20%), where both the average traffic rate and the packet drop rate are each computed over 10 samples such that the significance of the last 3 samples is increased, relative to the previous seven samples, by 15%.

FIGS. 2A and 2B are simplified flowchart illustrations of two preferred implementations of step 130 of FIG. 1 which differ in the method by which the consumed unreservable capacity is adjusted to the new consumed unreservable capacity.

In FIG. 2A, the consumed unreservable capacity is made unreservable by locking an appropriate portion of the link's physical capacity.

In FIG. 2B, the amount of reserved capacity allocated to the fictitious client is changed, e.g., by invoking a client reservation protocol (such as the RSVP protocol) responsible for allocating capacity to new circuits.

### EXAMPLE I ILLUSTRATING THE METHOD OF FIGS. 1-2A

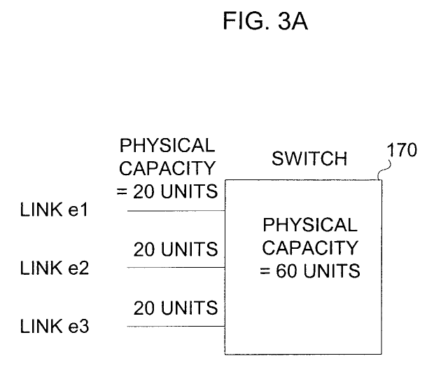

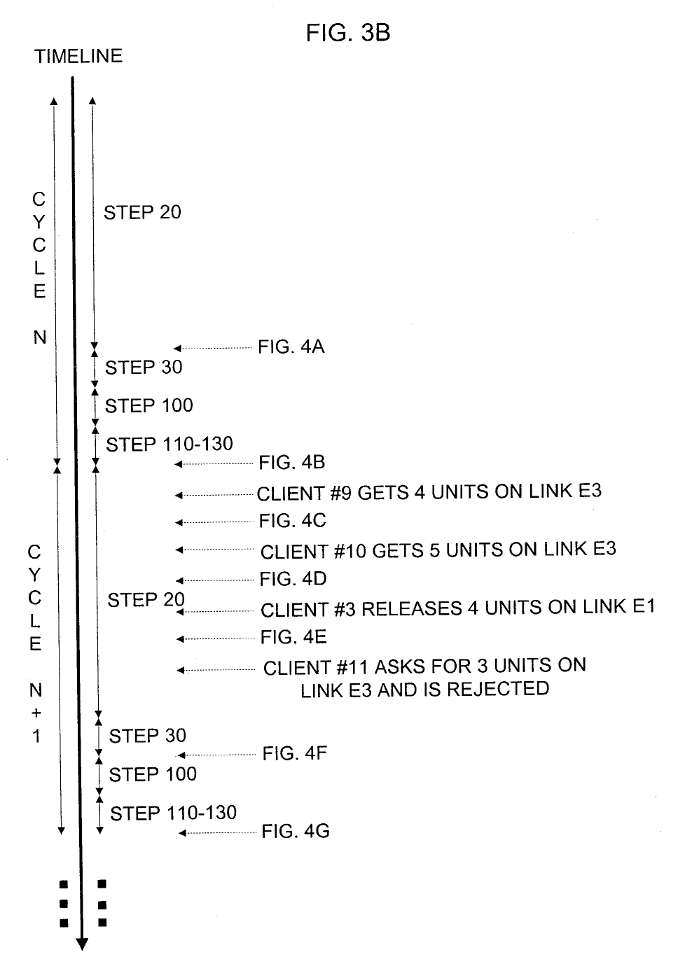

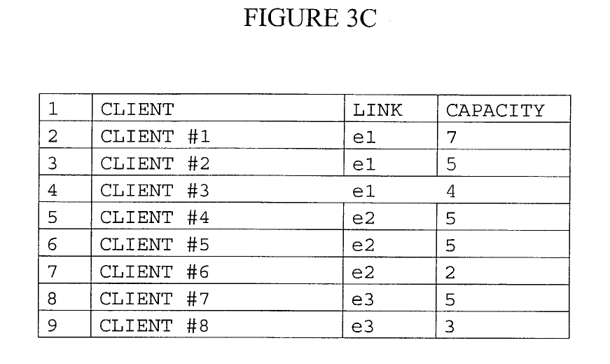

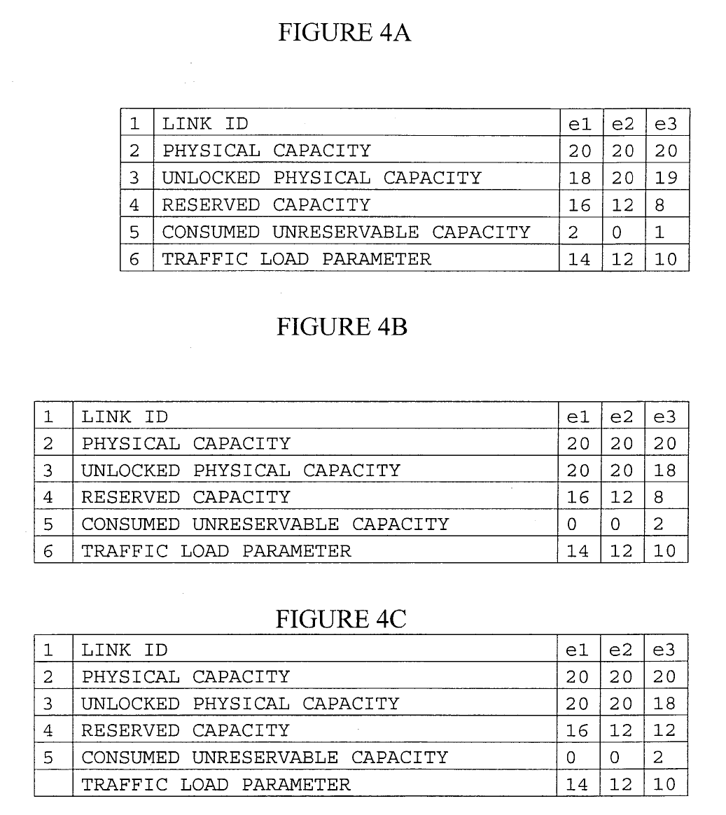

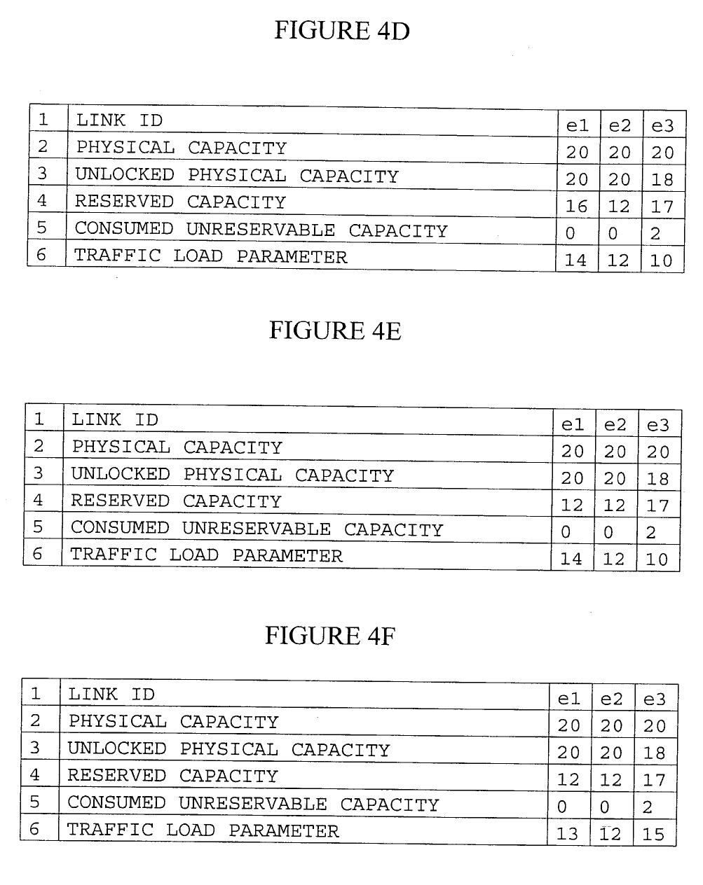

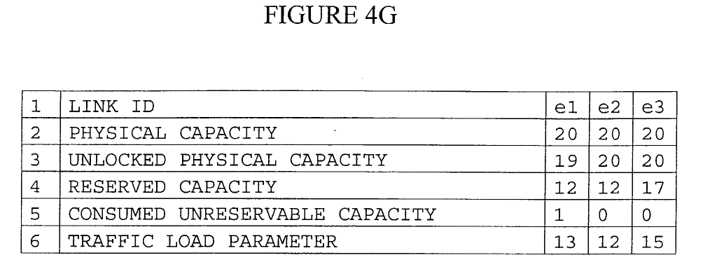

An example of a preferred operation of the method of FIG. 1 using the implementation of FIG. 2A is now described with reference to FIGS. 3A-4G. Cycle n, comprising steps 20, 30, 100-130 is now described in detail with reference to the example of FIGS. 3A-4B.

FIG. 3A is an example of a switch 170 with 3 associated links, for which the method of FIGS. 1-2A may be used to reduce congestion. FIG. 4A illustrates the contents of a table of computational results obtained after step 30 during a cycle n, by monitoring the switch 170 of FIG. 3A using the method of FIGS. 1 and 2A. The switch 170 of FIG. 3A, with a physical capacity of 60 units, is associated with three links, e1, e2 and e3, each with a physical capacity of 20 units. For example, each unit may comprise 155 Mb/sec. In the illustrated example, at the beginning of cycle n, the reserved capacities of the links e1, e2 and e3 are 16, 12 and 8 units, respectively. For example, four customers may have been assigned to the first link, and these may have purchased slices of 3, 4, 5, 4 capacity units respectively. Measurement of the traffic which, de facto, passes over the three links (step 20 of the previous cycle n−1) indicated that while portions of only 16, 12 and 8 units respectively of the three links' capacity had been purchased, 18, 12 and 9 units respectively were in fact in use.

Therefore, in step 110 of the previous cycle n−1, the consumed unreservable capacities of the links e1 and e3 were set at 18−16=2, and 9−8=1 units, respectively, as shown in FIG. 4A, fifth line. In step 120 of the previous cycle, the consumed unreservable capacity of link e2 was set at 0, also as shown in FIG. 4A, fifth line. The difference between the physical capacity and the consumed unreservable capacity is shown in line 3, labelled “unlocked physical capacity”. The client reservation protocol which the communication network employs in order to allocate capacity slices to clients, e.g. RSVP, is designed to allocate only unlocked physical capacity.

In cycle n, step 20, traffic over each of the three links is monitored e.g. by directly measuring the traffic every 10 seconds. Step 30 of FIG. 1 averages the traffic over the last few time intervals, e.g. 10 time intervals, thereby to determine the traffic load parameter for the links e1, e2 and e3 which in the present example is found to be 14, 12 and 10, respectively (line 6 of FIG. 4A).

FIG. 4B illustrates the contents of the table of computational results obtained after completion of cycle n, i.e. after completion of steps 100-130, steps 20 and 30 having already been completed as shown in FIG. 4A. It is appreciated that typically, initialization step 10 is performed only once, before cycle k=1.

In step 100, the traffic load parameter of e1, 14, is found to be less than the reserved capacity 16 and therefore, step 120 is performed for link e1. Step 120 therefore computes the new consumed unreservable capacity of link e1 as 0, and step 130 reduces the unreservable capacity of link e1 from its old value, 2, to its new value, 0, as shown in FIG. 4B, line 5, using the implementation of FIG. 2A.

For link e2, step 100 identifies the fact that the traffic load parameter of link e2 and its reserved capacity are equal (12). Step 120 is therefore not performed because the consumed unreservable capacity simply remains zero as shown in FIG. 4B, line 5.

For link e3, in step 100, the traffic load parameter of e3, 10, is found to be more than the reserved capacity 8 and therefore, step 110 is performed for link e3. Step 110 therefore computes the new consumed unreservable capacity of link e1 as 2, and step 130 increases the unreservable capacity of link e1 from its old value, 1, to its new value, 2, as shown in FIG. 4B, line 5, using the implementation of FIG. 2A.

The unlocked physical capacities of the 3 links are therefore adjusted, in step 140, to 20, 20 and 18 units respectively (FIG. 4B, line 3).

Cycle n+1 now begins, approximately 100 seconds after cycle n began. The traffic is monitored as above (step 20) and periodically recorded. FIG. 4C illustrates the contents of the table after a new client, client 9, has been assigned a four-unit slice of the capacity of link e3 as shown in FIG. 3B. As shown in FIG. 4C, line 4, the reserved capacity of e3 has been increased from 8 units to 12 units. FIG. 4D illustrates the contents of the table after a second new client, client 10, has been assigned a five-unit slice of the capacity of link e3 as shown in FIG. 3B. As shown in FIG. 4D, line 4, the reserved capacity of e3 has been increased again, this time from 12 units to 17 units.

FIG. 4E illustrates the contents of the table after an existing client, client 3, having a 3-unit slice of the capacity of link e1 has terminated its subscription as shown in FIG. 3B. As shown in FIG. 4E, line 4, the reserved capacity of e1 has been decreased from 16 units to 13 units.

At this point, as shown in FIG. 3B, client 11 asks for 3 units on link e3. Conventionally, the 3 units would be allocated to client 11 because the reserved capacity of link e3, 17, is 3 less than the physical capacity, 20, of link e3. However, according to a preferred embodiment of the present invention, the request of client 11 is denied because the unlocked physical capacity of link e3 is only 18, and therefore requests for slices exceeding 18−17=1 unit are rejected.

FIG. 4F illustrates the contents of the table obtained after step 30 during cycle n+1 by monitoring the switch 170 of FIG. 3A using the method of FIGS. 1 and 2A. As shown, in step 30, the traffic load parameter for link e2 remains unchanged whereas the traffic load parameter for e1 has decreased from 14 units to 13 units and the traffic load parameter for e3 has increased from 10 units to 15 units.

FIG. 4G illustrates the contents of the table of computational results obtained after completion of cycle n+1. As shown in line 6, in step 100, the traffic load parameter of e1, 13, is found to be greater than the reserved capacity 12 and therefore, step 110 is performed for link e1. Step 110 therefore resets the consumed unreservable capacity of link e1 from 0 to 1, as shown in FIG. 4G, line 5, using the implementation of FIG. 2A.

For link e2, step 100 identifies the fact that the traffic load parameter of link e2 and its reserved capacity are equal (12). Step 120 is therefore not performed because the consumed unreservable capacity simply remains zero as shown in FIG. 4G, line 5.

For link e3, in step 100, the traffic load parameter of e3, 15, is found to be less than the reserved capacity 17 and therefore, step 120 is performed for link e3. Step 130 therefore resets the consumed unreservable capacity of link e3 from 2 to 0, as shown in FIG. 4G, line 5, typically using the implementation of FIG. 2A.

The unlocked physical capacities of the 3 links are therefore adjusted, in step 140, to 19, 20 and 20 units respectively (FIG. 4G , line 3).

### EXAMPLE II ILLUSTRATING THE METHOD OF FIGS. 1-2B

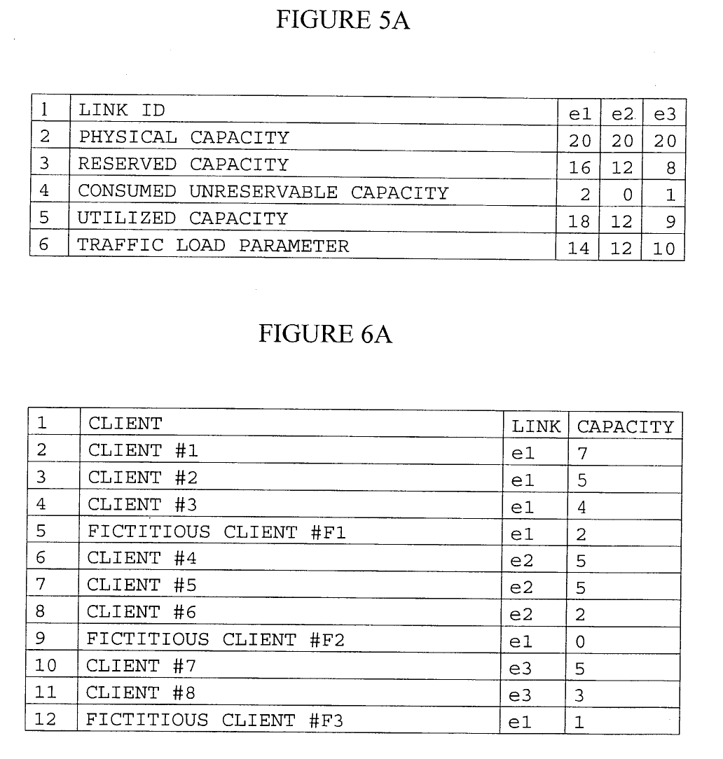

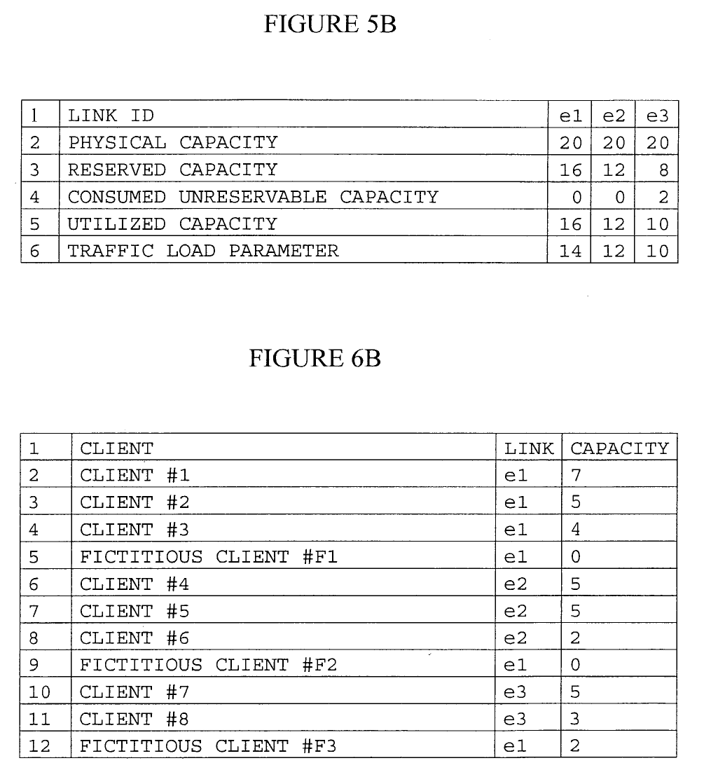

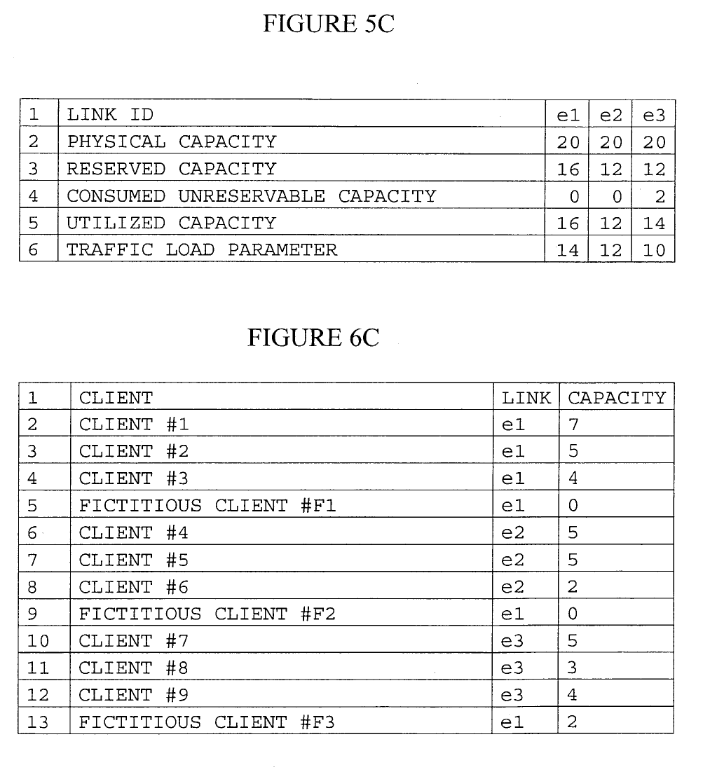

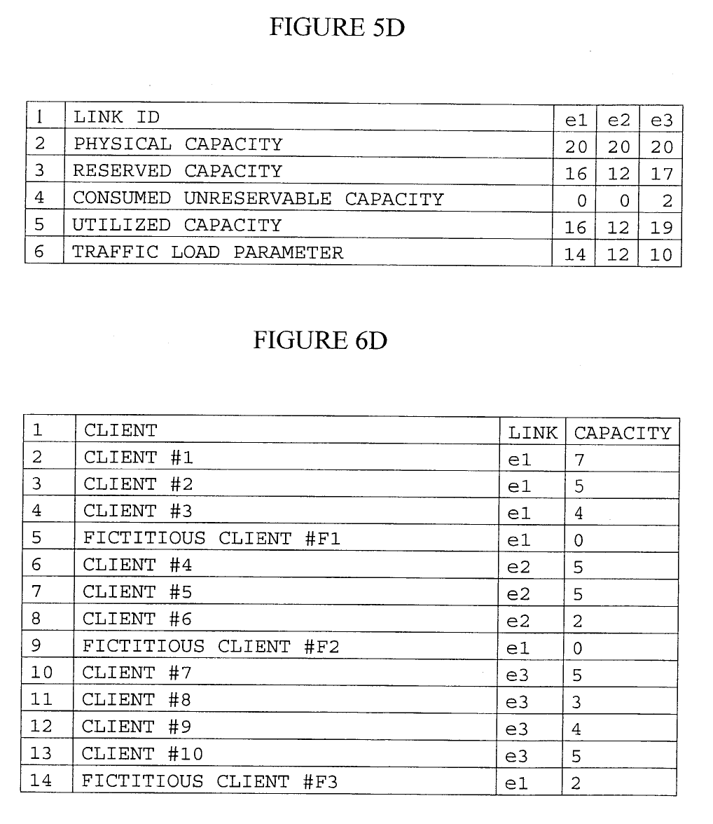

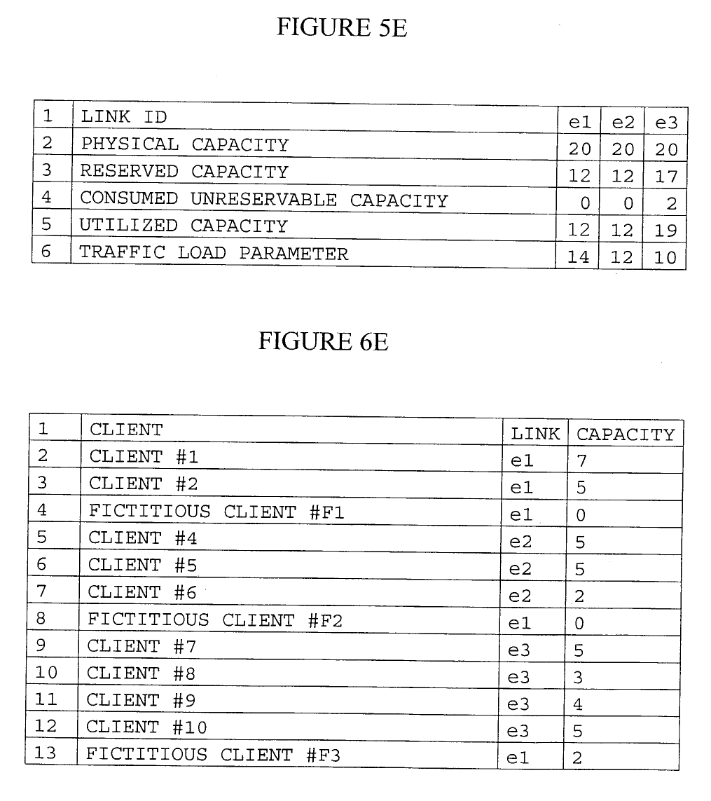

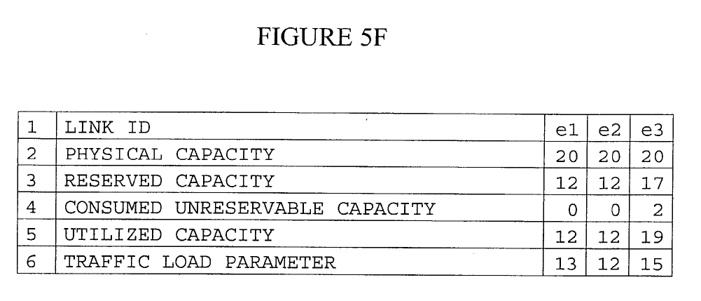

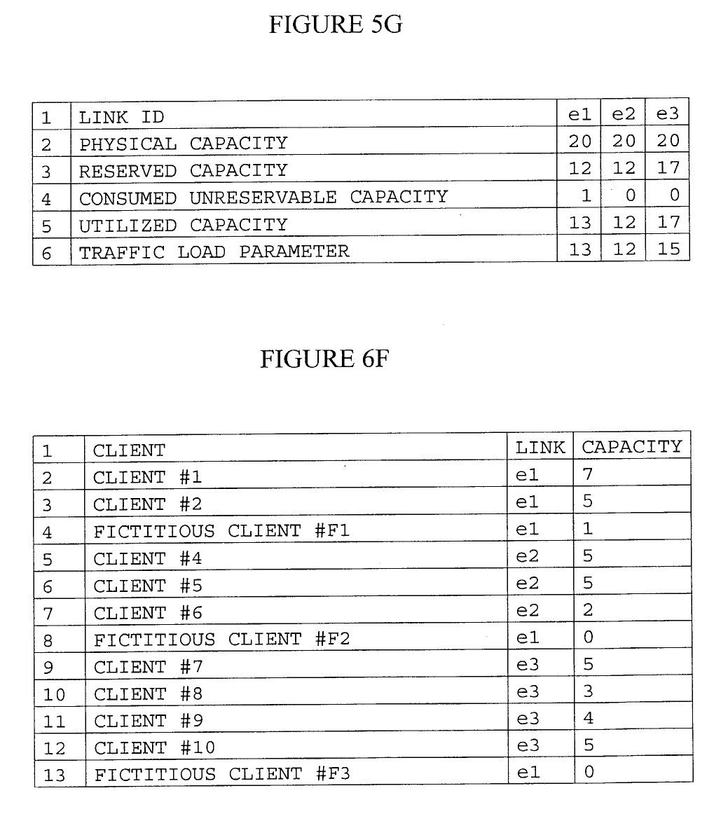

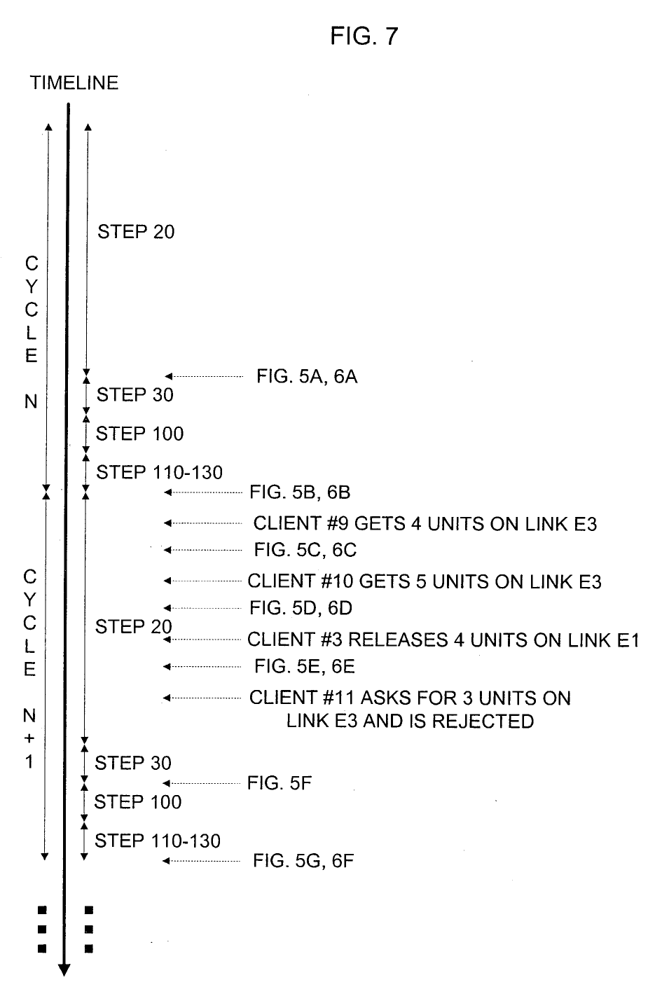

An example of a preferred operation of the method of FIG. 1 using the implementation of FIG. 2B is now described with reference to FIGS. 5A-6F. The timeline of events in Example II, for simplicity, is taken to be the same as the timeline of Example I. The timeline of FIG. 7, therefore, shows the same events as the timeline of FIG. 3B. Cycle n, comprising steps 20, 30, 100-130 is now described in detail with reference to the example of FIGS. 3A, 5A-7.

FIG. 3A is an example of a switch 170 with 3 associated links, for which the method of FIGS. 1 and 2B may be used to reduce congestion. FIG. 5A illustrates the contents of a table of computational results obtained after step 30 during a cycle n, by monitoring the switch of FIG. 3A using the method of FIGS. 1 and 2B. The switch 170 of FIG. 3A, with a physical capacity of 60 units, is associated with three links, e1, e2 and e3, each with a physical capacity of 20 units. In the illustrated example, at the beginning of cycle n, the reserved capacities of the links e1, e2 and e3 are 16, 12 and 8 units, respectively. For example, four customers may have been assigned to the first link, and these may have purchased 3, 4, 5, 4 units respectively. Measurement of the traffic which, de facto, passes over the three links (step 20 of the previous cycle n−1) indicated that while slices of only 16, 12 and 8 units respectively of the three links, capacity had been purchased, 18, 12 and 9 units respectively were in fact in use.

Therefore, in step 110 of the previous cycle, the consumed unreservable capacities of the links e1 and e3 were set at 18−16=2, and 9−8=1 units, respectively, as shown in FIG. 5A, line 4. In step 120 of the previous cycle, the consumed unreservable capacity of link e2 was set at 0, also as shown in FIG. 5A, line 4. The consumed unreservable capacity was made unreservable by assigning it to the fictitious clients over the three links, as shown in FIG. 6A. FIG. 6A is a list of allocations to clients, three of whom (corresponding in number to the number of links) are fictitious, as shown in lines 5, 9 and 12, according to a preferred embodiment of the present invention. In particular, the fictitious client F1, defined on behalf of link e1, was assigned a capacity slice of 2 units, the fictitious client F2, defined on behalf of link e2, was assigned a capacity slice of 0 units and the fictitious client F3, defined on behalf of link e3, was assigned a capacity slice of 1 units, as shown in FIG. 6A in lines 5, 9 and 12 respectively.

In cycle n, step 20, traffic over each of the three links is monitored e.g. by directly measuring the traffic every 10 seconds. Step 30 of FIG. 1 averages the traffic over the last few time intervals, e.g. 10 time intervals, thereby to determine the traffic load parameter for the links e1, e2 and e3 which in the present example is found to be 14, 12 and 10, respectively (line 6 in FIG. 5A).

It is appreciated that line 5 of FIG. 5A illustrates the utilized capacity of each link, i.e. the sum of the capacities reserved for each of the genuine clients, and the additional consumed unreservable capacity allocated to the fictitious client defined for that link in order to prevent consumed capacity from being reserved. Similarly, line 5 of FIGS. 5B-5G illustrate the utilized capacity of each link at the timepoints indicated in FIG. 7.

FIG. 5B illustrates the contents of the table of computational results obtained after completion of cycle n, i.e. after completion of steps 100-130 steps 20 and 30 having already been completed as shown in FIG. 5A. It is appreciated that typically, initialization step 10 is performed only once, before cycle k=1.

In step 100, the traffic load parameter of e1, 14, is found to be less than the reserved capacity 16 and therefore, step 120 is performed for link e1. Step 120 therefore resets the consumed unreservable capacity of link e1 from 2 to 0, as shown in line 4 of FIG. 5B. According to the implementation of FIG. 2B, the fictitious client F1's allocation therefore is reduced from 2 to 0 similarly, as shown in line 5 of FIG. 6B.

For link e2, step 100 identifies the fact that the traffic load parameter of link e2 and its reserved capacity are equal (12). Step 120 is therefore not performed because the consumed unreservable capacity simply remains zero as shown in FIG. 5B.

For link e3, in step 100, the traffic load parameter of e3, 10, is found to be more than the reserved capacity 8 and therefore, step 110 is performed for link e3. Step 110 therefore resets the consumed unreservable capacity of link e3 from 1 to 2, as shown in FIG. 5B. According to the implementation of step 130 shown in FIG. 2B, the fictitious client F3's allocation therefore is increased from 1 to 2 similarly, as shown in line 12 of FIG. 6B.

Cycle n+1 now begins, perhaps 100 seconds after cycle n began. The traffic is monitored as above (step 20) and periodically recorded. FIG. 5C illustrates the contents of the table after a new client, client 9, has been assigned a four-unit slice of the capacity of link e3 as shown in FIG. 7. As shown in FIG. 5C, line 3, the reserved capacity of e3 has been increased from 8 units to 12 units. The new client 9 has been added to the client list as shown in FIG. 6C.

FIG. 5D illustrates the contents of the table after a second new client, client 10, has been assigned a five-unit slice of the capacity of link e3 as shown in FIG. 7. As shown in FIG. 5D, line 3, the reserved capacity of e3 has been increased again, this time from 12 units to 17 units. The new client 10 has been added to the client list as shown in FIG. 6D.

FIG. 5E illustrates the contents of the table after an existing client, client 3, having a 3-unit slice of the capacity of link e1 has terminated its subscription as shown in FIG. 7. As shown in FIG. 5E, line 3, the reserved capacity of e1 has been decreased from 16 units to 13 units. The client 3 has been deleted from the client list as shown in FIG. 6E.

At this point, as shown in FIG. 7, client 11 asks for 3 units on link e3. Conventionally, the 3 units would be allocated to client 11 because the reserved capacity of link e3, 17, is 3 less than the physical capacity, 20, of link e3. However, according to a preferred embodiment of the present invention, the request of client 11 is denied because the utilized capacity of link e3 is 19, and therefore requests for slices exceeding 20−19=1 units are rejected.

FIG. 5F illustrates the contents of the table obtained after step 30 during cycle n+1 by monitoring the switch 170 of FIG. 3A using the method of FIGS. 1 and 2B. As shown in FIG. 5F, line 6, in step 30, the traffic load parameter for e2 remains unchanged whereas the traffic load parameter for e1 has decreased from 14 units to 13 units and the traffic load parameter for e3 has increased from 10 units to 15 units.

FIG. 5G illustrates the contents of the table of computational results obtained after completion of cycle n+1. As shown, in step 100, the traffic load parameter of e1, 13, is found to be greater than the reserved capacity 12 and therefore, step 110 is performed for link e1. Step 130 therefore resets the consumed unreservable capacity of link e1 from 0 to 1, as shown in FIG. 5G, using the implementation of FIG. 2B whereby fictitious client F1, previously having no allocation, is now allocated one unit on link e1 (FIG. 6F, Row 4).

For link e2, step 100 identifies the fact that the traffic load parameter of link e2 and its reserved capacity are equal (12). Step 120 is therefore not performed because the consumed unreservable capacity simply remains zero as shown in FIG. 5G.

For link e3, in step 100, the traffic load parameter of e3, 15, is found to be less than the reserved capacity 17 and therefore, step 120 is performed for link e3. Step 130 therefore resets the consumed unreservable capacity of link e3 from 2 to 0, as shown in FIG. 5B, using the implementation of FIG. 2B whereby fictitious client F3 releases its 2 units back to link e3 and has a zero allocation on that link (FIG. 6F, Row 13).

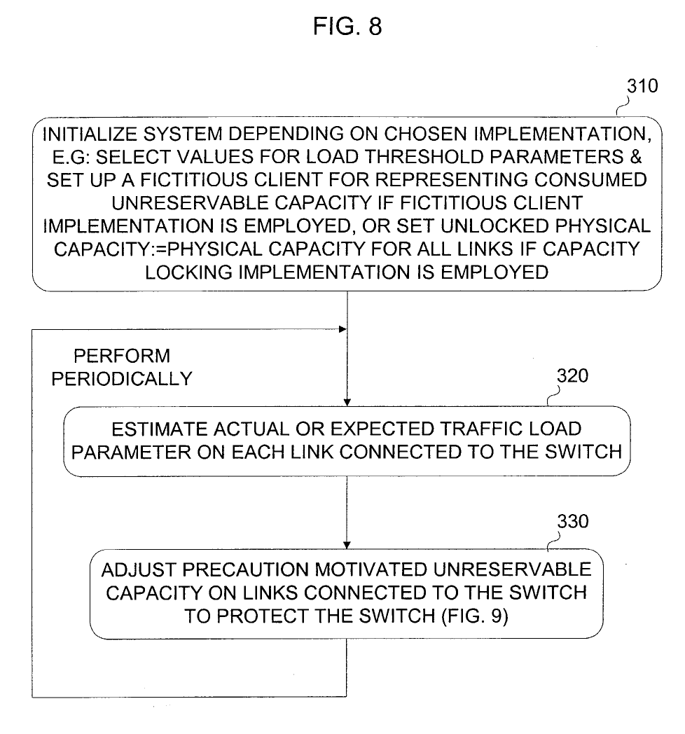

Reference is now made to FIG. 8 which is a simplified flowchart illustration of a second traffic engineering method for reducing congestion in a communication network. The method of FIG. 8 diminishes the free capacity of a switch, through diminishing the free capacity of some of the links connected to it, by locking or by defining a fictitious client, as a function of the total load on the switch as opposed to only as a function of the utilizations of individual links.

The method of FIG. 8 preferably includes at least one switch connected to a plurality of links, each link having a defined physical capacity, the method being operative in accordance with a second preferred embodiment of the present invention and including computing an expected traffic load parameter over each link connected to at least one switch and restricting allocation of at least a portion of the capacity of at least one of the links if the expected traffic load parameter exceeds a threshold.

In FIG. 8, after a self-explanatory initialization step 310, step 320 is performed for at least one switches. For each such switch, the actual or expected traffic load parameter is computed for each of the links connected to the switch. Computation of the actual traffic load parameter is described above with reference to step 30 of FIG. 1. Estimation of an expected traffic load parameter can be performed by any suitable estimation method. For example, it is possible to base the estimate at least partly on prior knowledge regarding expected traffic arrivals or regarding periodic traffic patterns. Alternatively or in addition, it is possible to base the estimate at least partly on recent traffic pattern changes in order to predict near future traffic pattern changes.

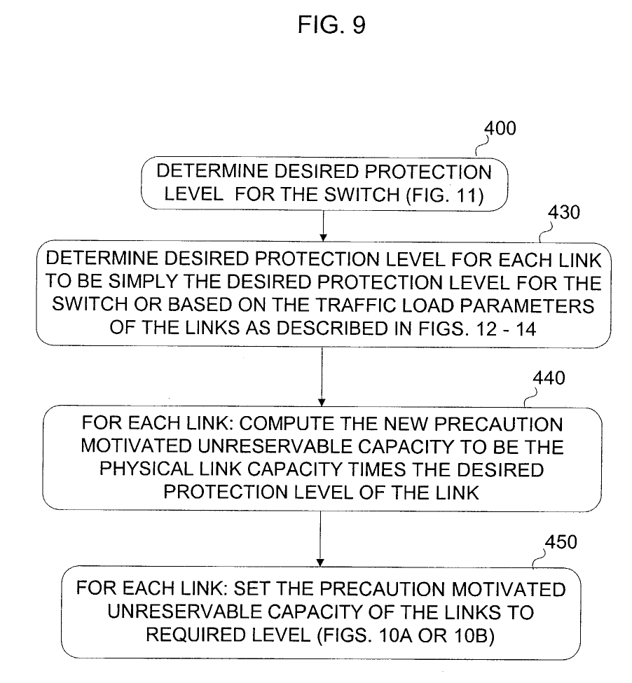

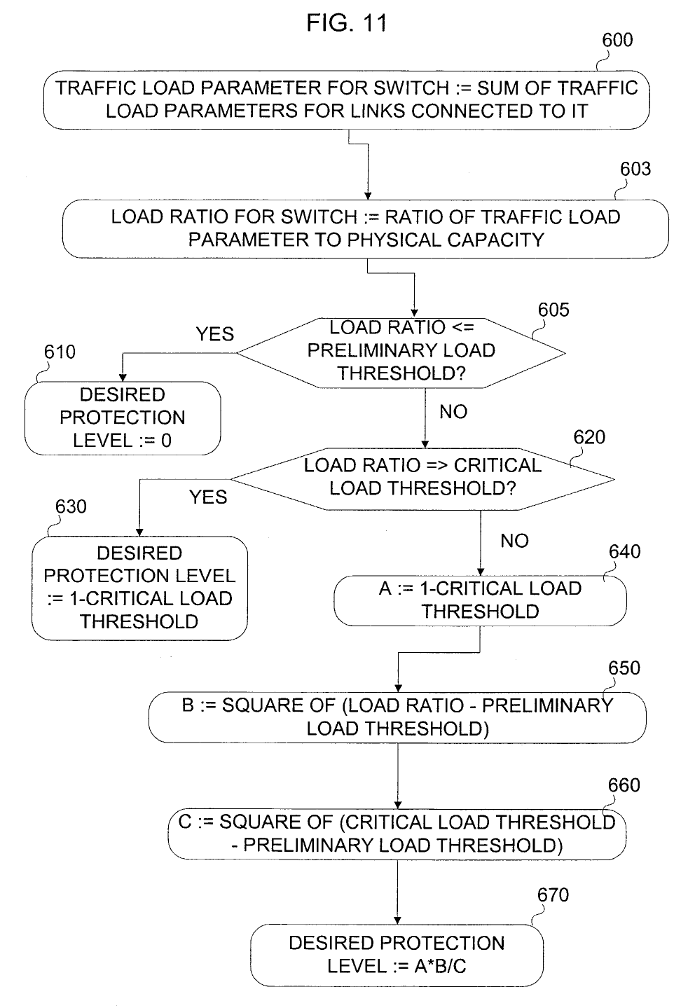

FIG. 9 is a simplified flowchart illustration of a preferred implementation of step 330 in FIG. 8 and of step 1360 in FIG. 18. In step 400, a preferred implementation of which is described below with reference to FIG. 11, the desired protection level of the switch is determined.

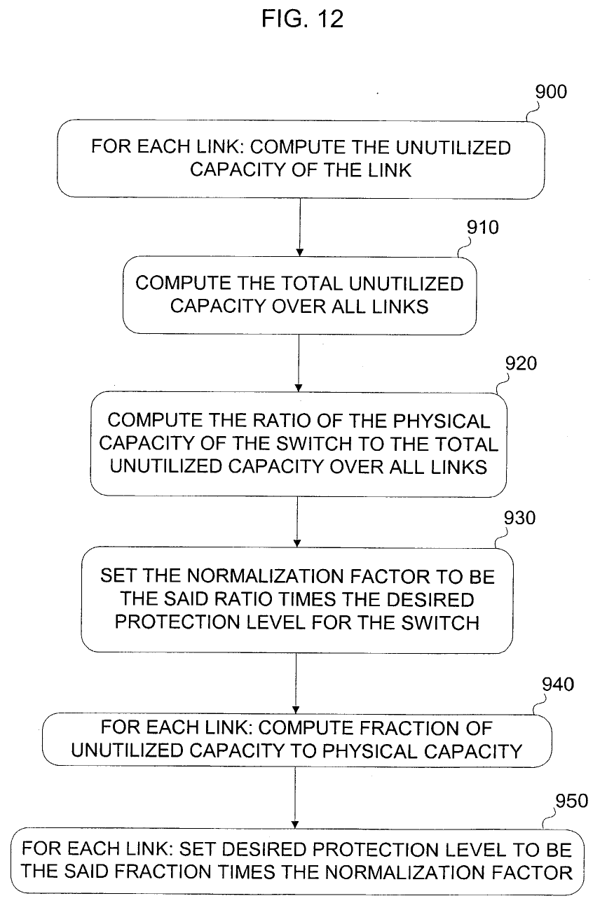

After completion of step 400, step 430 is performed to derive a desired protection level for each link. Any suitable implementation may be developed to perform this step. One possible implementation is simply to adopt the desired protection level computed in step 400 for the switch as the desired protection level for each link. Alternative implementations of step 430 are described below with reference to FIGS. 12, 13 and 14.

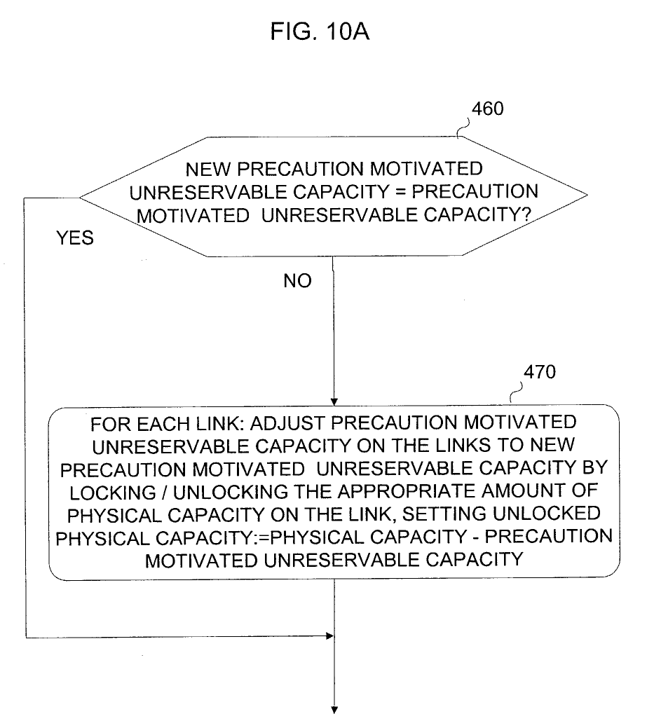

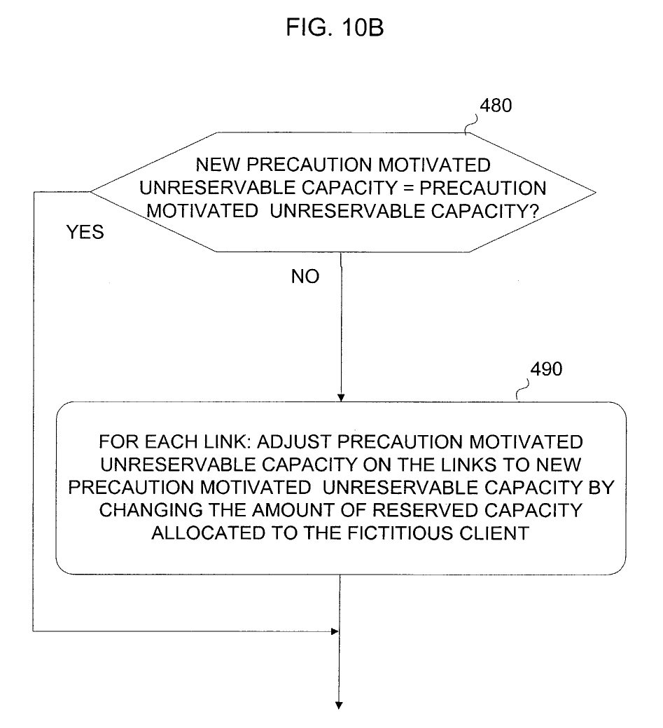

FIG. 10A is a simplified flowchart illustration of a first preferred implementation of step 450 of the method of FIG. 9 in which the precaution motivated unreservable capacity on the links is set by locking or unlocking a portion of the physical capacity of the link. FIG. 10B is a simplified flowchart illustration of a second preferred implementation of step 450 of the method of FIG. 9 in which the precaution motivated unreservable capacity on the links is set by changing the amount of reserved capacity allocated to the fictitious client on each link.

FIG. 11 is a simplified flowchart illustration of a preferred implementation of step 400 in FIG. 9.

Typically, two system parameters are provided to define the desired protection level for the switch. The first is the preliminary load threshold. While the load ratio of the switch is below this threshold, no protection is necessary. The second parameter is the critical load threshold. Once the load ratio of the switch is beyond this threshold, the switch is deemed overloaded because it is expected to perform poorly e.g. to lose packets. The method starts making capacity unreservable once the load ratio of the switch exceeds the switch's preliminary load threshold, and turns all the remaining unutilized capacity into precaution motivated unreservable capacity once the switch load ratio reaches the critical load threshold.

In accordance with the embodiment of FIG. 11, the following operations are performed:

Set the desired switch protection level to 0 (step 610) so long as the load ratio is below the preliminary load threshold (step 605).

When the switch load ratio is between preliminary threshold load and critical load threshold (step 620), the protection level is set to:

(1-critical load threshold)*(load ratio-preliminary load threshold)\hat{ }2/(critical load threshold−preliminary load threshold)\hat{ }2 (step 670).

Once the load ratio exceeds critical load threshold (step 620), the desired switch protection level is set to 1-critical load threshold (step 630), i.e. all unutilized capacity is to be locked.

FIG. 12 is a simplified self-explanatory flowchart illustration of a first alternative implementation of desired protection level determination step 430 in FIG. 9. In FIG. 12, the desired protection level for each link is selected so as to ensure that the percentage of each link's currently unutilized capacity which is reservable is uniform over all links.

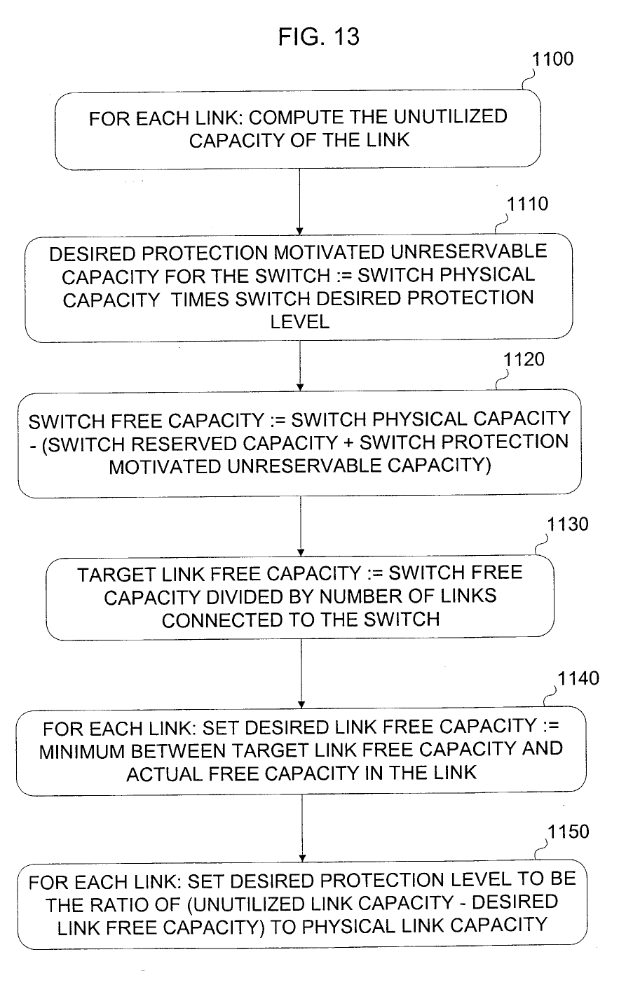

FIG. 13 is a simplified self-explanatory flowchart illustration of a second alternative implementation of step 430 in FIG. 9.

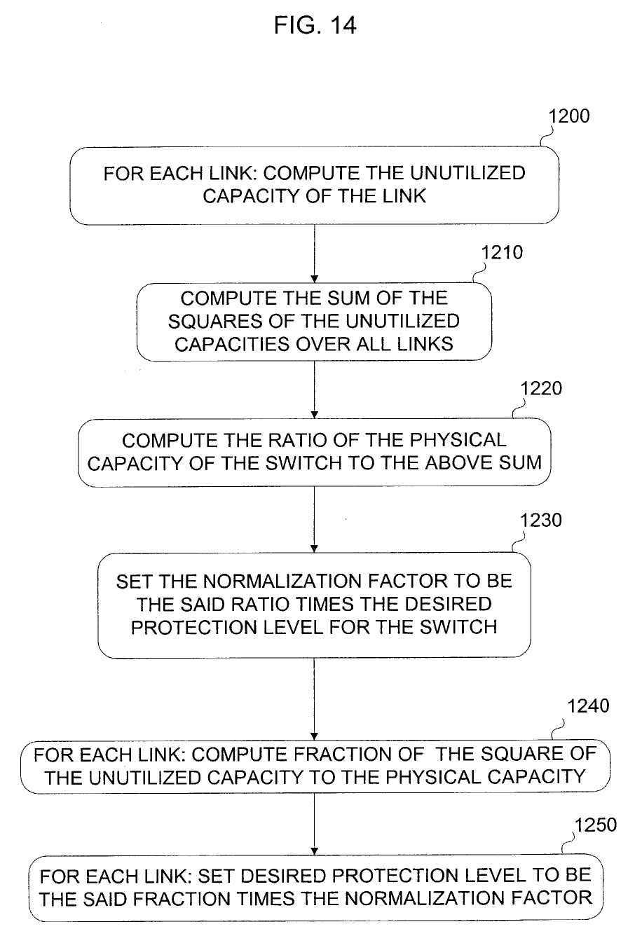

FIG. 14 is a simplified self-explanatory flowchart illustration of a third alternative implementation of step 430 in FIG. 9. STEP 1200 of FIG. 14 may be similar to Step 900 in FIG. 12.

### EXAMPLE III ILLUSTRATING THE METHODS OF FIGS. 8-14

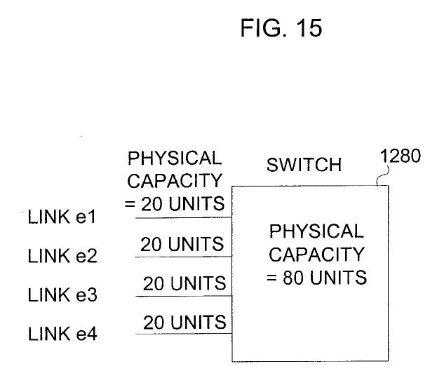

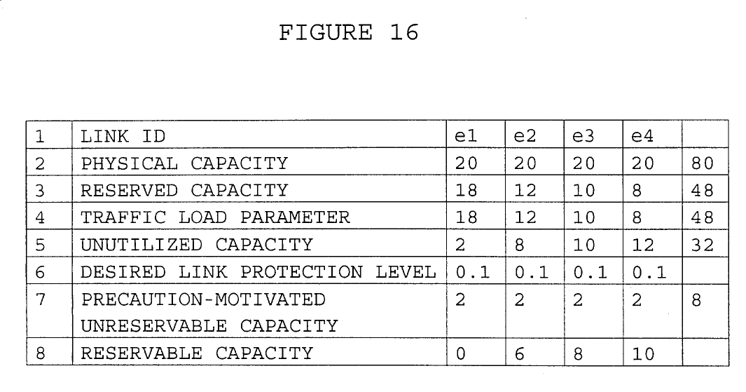

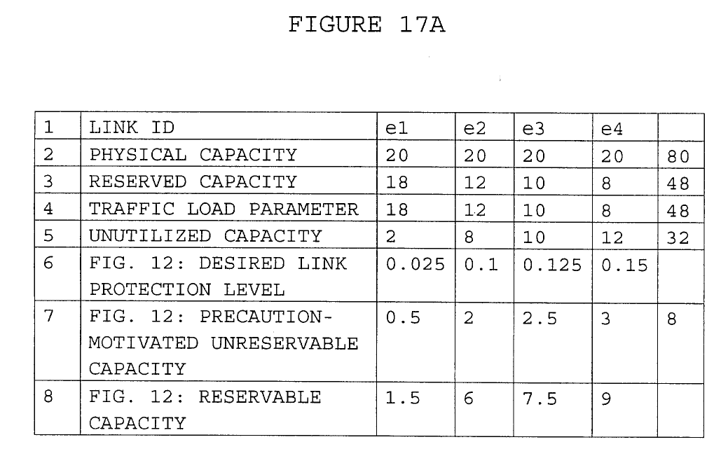

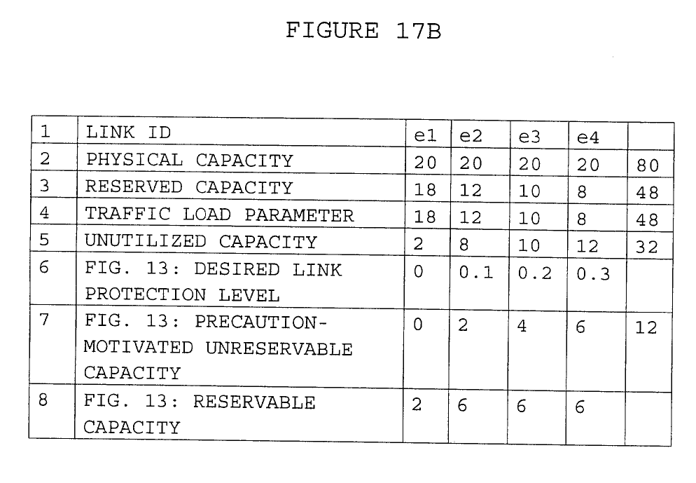

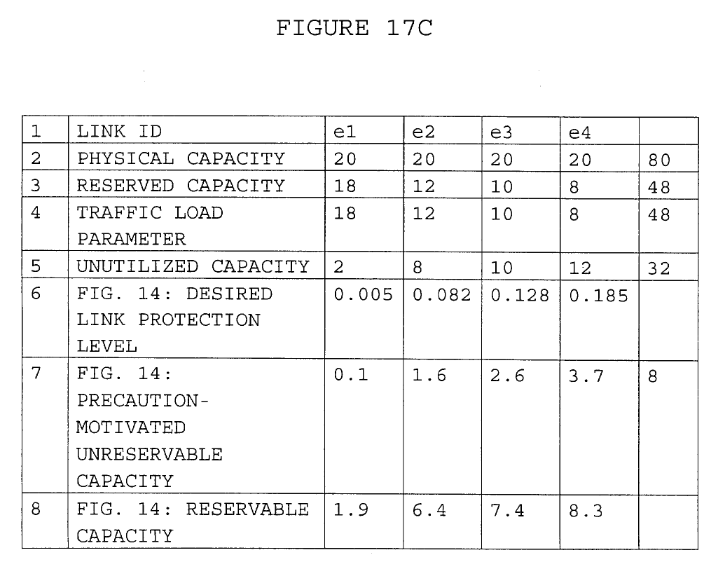

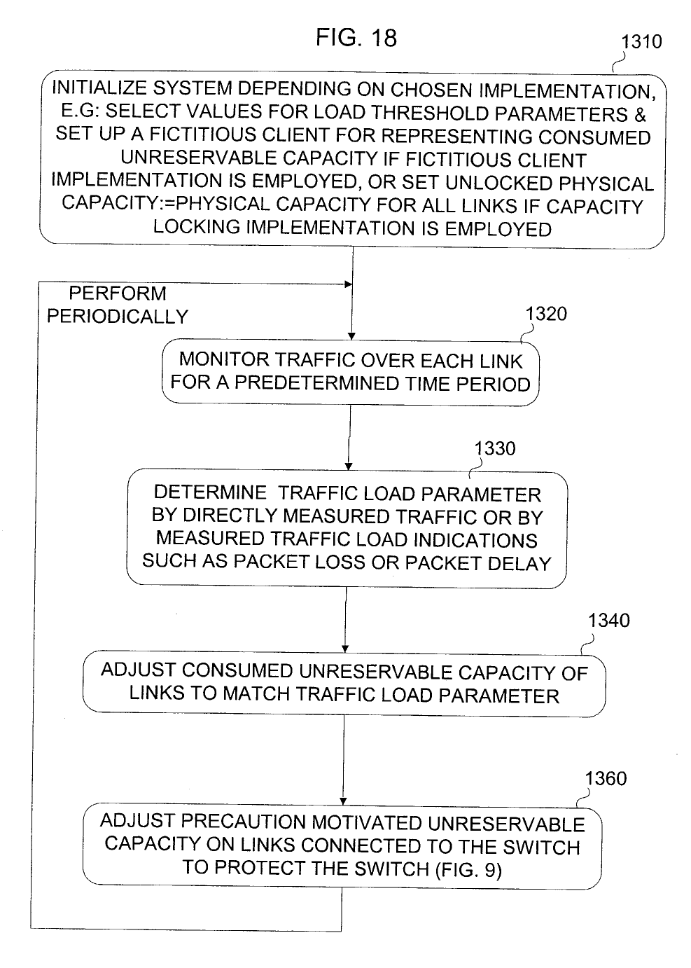

An example of a preferred operation of the method of FIGS. 8-14 is now described with reference to FIGS. 15, 16, and 17A-17C respectively. FIG. 15 is an example of a switch 1280 with 4 associated links, for which the method of FIGS. 8-11 and, optionally, the variations of FIGS. 12-14 may be used to reduce congestion. FIG. 16 is a table of computational results obtained by monitoring the switch 1280 of FIG. 15 using the method of FIGS. 8-11 wherein step 430 of FIG. 9 is implemented by defining each link's desired protection level as the switch's desired protection level. FIGS. 17A-17C are tables of computational results respectively obtained by monitoring the switch 1280 of FIG. 15 using the method of FIGS. 8-11 wherein the variations of FIGS. 12-14 respectively are used to implement step 430 of FIG. 9.

A switch is provided with physical capacity of 80 units, with four links e1, e2, e3, e4, each with physical capacity of 20 units as shown in FIG. 15 and in FIGS. 16, 17A—Currently, as shown in the tables of FIGS. 16 and 17A-17C at line 3, the capacities reserved by the client reservation protocol for the links e1, e2, e3 and e4, typically comprising the sum of valid requests for each link, are 18, 12, 10 and 8 units, respectively. Therefore, the total reserved capacity of the switch is 48 units.

The method of FIG. 8 is employed to compute an expected traffic load parameter over each of the links e1, . . . , e4 in order to determine whether it is necessary to restrict allocation of a portion of the capacity of one or more links, due to a high expected load ratio which approaches or even exceeds a predetermined maximum load ratio which the switch can handle.

In step 310, suitable values are selected for the preliminary and critical load threshold parameters. For example, the preliminary load threshold may be set to 0.4, if the switch has been found to operate substantially perfectly while the actual traffic is no more than 40 percent of the physical capacity. The critical load threshold may be set to 0.73 if the switch has been found to be significantly inoperative (e.g. frequent packet losses), once the actual traffic has exceeded 73 percent of the physical capacity.

It is appreciated that these parameters may be adjusted based on experience during the system's lifetime. If the fictitious client implementation described above with reference to FIGS. 1 and 2B is employed, a fictitious client with an initial, zero allocation is typically defined. If the capacity locking implementation described above with reference to FIGS. 1 and 2A is employed, the unlocked physical capacity of each link is set to the link's total physical capacity i.e. 20 in this Example.

In Step 320, the traffic over the links is measured and the traffic load parameter computed for the links e1 through e4, e.g. as described above with reference to FIG. 1, blocks 20 and 30. The traffic load parameter for these links is found, by measurement and computation methods e.g. as described with reference to FIG. 1, to be 18, 12, 10 and 8 units, respectively, so the total traffic load parameter of the switch is 48 units.

A preferred implementation of Step 330 is now described with reference to FIG. 9. As shown in FIG. 9, Step 400 computes, using the method of FIG. 11, a desired protection level for the switch. As described below with reference to FIG. 11, the desired switch protection level is found to be 0.1 indicating that 10 percent of the switch's total physical capacity (8 units, in the present example) should be locked. It is appreciated that the particular computations (e.g. steps 640, 650, 660) used in FIG. 11 to compute protection level are not intended to be limiting.

After completion of step 400 of FIG. 9, step 430 is performed to derive a desired protection level for each link. Any suitable implementation may be developed to perform this step, e.g. by setting the desired protection level for each of the 4 links to be simply the desired protection level for the switch, namely 10%, as shown in line 6 in the table of FIG. 16, or using any other suitable implementation such as any of the three implementations described in FIGS. 12-14.

Using the implementation of FIG. 12, for example, the desired protection levels for the links e1 to e4 are found to be 2.5%, 10%, 12.5% and 15% respectively, as shown in line 6 of FIG. 17A and as described in detail below with reference to FIG. 12. Line 6 in FIGS. 17B and 17C shows the desired protection levels for links e1 to e4 using the computation methods of FIGS. 13 and 14 respectively.

In Step 440 of FIG. 9, for the links e1 through e4, the precaution motivated unreservable capacities are computed from the desired protection levels found in step 430. Using the implementation given in step 430 itself, which is to set the desired protection level for each link to be the same as the desired protection level for the switch, namely, 0.1, this yields, for each of the links e1 through e4, a precaution motivated unreservable capacity of 0.1×20=2, summing up to 8 units, as shown in FIG. 16, line 7. Results of employing other more sophisticated methods (FIGS. 12-14) for implementing step 440 and computing the precaution motivated unreservable capacities for links e1-e4, are shown in the tables of FIGS. 17A-17C respectively. The values in line 7 of these tables are products of respective values in line 6 and in line 2. For example, for link e1, in FIG. 17A, 0.025×20=0.5. For the links e2 through e4, as shown in FIG. 17A, line 7, the precaution motivated unreservable capacities are 0.1×20=2, 0.125×20=2.5 and 0.15×20=3 units, respectively. The sum of the precaution motivated unreservable capacities, over all links, is shown in the rightmost column of line 7 of FIG. 17A to be 8 units.

In step 450 of FIG. 9, the precaution motivated unreservable capacity of each link is brought to the new value computed in step 440. For example, for link e1 using the method of FIG. 12, the new precaution motivated unreservable capacity is 0.5 as shown in line 7 of FIG. 17A. Therefore, the new reservable capacity goes down to 1.5, as shown in line 8 of FIG. 17A, because the unutilized capacity of link e1, as shown in line 5, is 2 units. More generally, the reservable capacity values in line 8 of FIGS. 16 and 17A-17C are the difference between the respective values in lines 5 and 7.

Any suitable implementation may be employed to bring the precaution motivated unreservable capacity to its new level. A “locking” implementation, analogous to the locking implementation of FIG. 2A, is shown in FIG. 10A and a “fictitious client” implementation, analogous to the locking implementation of FIG. 2B, is shown in FIG. 10B. For example, using the “locking” method of FIG. 10A, the new precaution motivated unreservable capacity of 0.5 for link e1 according to the method of FIG. 12 (see FIG. 17A, line 7) may be implemented by reducing the unlocked physical capacity of link e1 from 20 units to 19.5 units. Using the “fictitious client” method of FIG. 10B, the new precaution motivated unreservable capacity of 0.5 for link e1 according to the method of FIG. 12 (see FIG. 17A, line 7) may be implemented by setting the capacity slice allocated to the fictitious client defined in set-up step 310 at 0.5 units.

The operation of FIG. 11, using Example III, is now described.

In FIG. 11, Step 600 computes the traffic load parameter of the switch to be 18+12+10+8=48.

Step 603 computes the load ratio of the switch to be 48/80=0.6.

Step 605 observes that the switch load ratio (0.6) is higher than the preliminary threshold load (0.4) defined in step 310.

Step 620 observes that the switch load ratio (0.6) is lower than the critical load threshold (0.73), so the method proceeds to step 640.

In Step 640, A is set to 1−0.73=0.27.

In Step 650, B is set to (0.6−0.4)*(0.6−0.4)=0.04.

In Step 660, C is set to (0.73−0.4)*(0.73−0.4)=0.1089.

In Step 670, the desired protection level of the switch is set to 0.27*0.04/0.1089=0.1.

The operation of FIG. 12, using Example III, is now described with reference to FIG. 17A. In STEP 900, the unutilized capacity of a link is computed as the total physical capacity of the link minus the traffic load parameter. The traffic load parameter, as explained herein, may comprise an expected traffic load parameter determined by external knowledge, or an actual, measured traffic load parameter. In the present example, referring to FIG. 17A, the unutilized capacity of each link (line 5 of FIG. 17A) is computed to be the physical capacity (line 2) minus the traffic load parameter (line 4) yielding for links e1 through e4, unutilized capacity values of 2, 8, 10 and 12 units, respectively.

In Step 910, the total unutilized capacity of the switch is computed to be 32 units, by summing the values in line 5 of FIG. 17A.

Step 920 computes:

switch's physical capacity/links' unutilized capacity=80/32=2.5.

Step 930, using the desired protection level of 0.1 at the switch, as computed in step 400 of FIG. 9, computes a “normalization factor” to be 2.5×0.1=0.25.

Step 940 computes, for each link, the following ratio: unutilized capacity/physical capacity. The values for links e1 to e4 are found to be 2/20=0.1, 8/20=0.4, 10/20=0.5 and 12/20=0.6, respectively.

Step 950 computes the desired protection levels for each of the links e1 through e4, to be 0.1×0.25=0.025, 0.4×0.25=0.1, 0.5×0.25=0.125 and 0.6×0.25=0.15, respectively, as shown in FIG. 17A, line 6.

The operation of FIG. 13, using Example III, is now described with reference to FIG. 17B. In step 1100, as in step 900 of FIG. 12, the unutilized capacity of each link (FIG. 17B, line 5) is computed to be the physical capacity (line 2) minus the traffic load parameter (line 4) yielding for links e1 through e4, unutilized capacity values of 2, 8, 10 and 12 units, respectively.

Step 1110 computes the precaution motivated unreservable capacity for the switch to be the product of the desired switch protection level computed in step 400 of FIG. 9 and the switch's physical capacity, i.e. in the current example, 0.1×80=8.

Step 1120 computes the reservable capacity for the switch to be the switch's capacity, minus its reserved capacity, minus its unreservable capacity, i.e. in the current example, 80−48−8=24 units.

Step 1130 computes, for each link, its share of the switch's free capacity, also termed herein the link's “target free capacity”, typically by simply dividing the switch's free capacity as computed in step 1120, by the number of links on the switch, i.e. in the current example, 24/4=6 units.

Step 1140 computes the new link free capacity of the links e2, e3 and e4 to be 6 units, and of the link e1 to be 2 capacity units because the unutilized capacity of link e1 is only 2 units as shown in line 5 of FIG. 17B.

Step 1150 computes the desired protection level for the links in FIG. 15 to be, as shown in FIG. 17B, line 6: (2−2)/20=0 for e1, (8−6)/20=0.1 for e2, (10−6)/20=0.2 for e3 and (12−6)/20=0.3 for e4. The numerator of the ratio computed in step 1150 is the difference between the values in line 5 of FIG. 17B and the values computed for the respective links in step 1140 (FIG. 17B, line 8). The denominators are the physical capacities of the links, appearing in FIG. 17B, line 2.

In summary, the output of step 430 in FIG. 9, using the method of FIG. 13, is (0, 0.1, 0.2, 0.3) for links e1-e4 respectively. Proceeding now to Step 440 of FIG. 9, these values yield, for the links e1 through e4, a new precaution motivated unreservable capacity of 0×20=0, 0.1×20=2, 0.2×20=4 and 0.3×20=6 units, respectively, computed by multiplying each link's desired protection level (FIG. 17B, line 6) by that link's physical capacity (FIG. 17B, line 2). The total precaution motivated unreservable capacity in this example is 12 units i.e. in excess of the switch's desired protection level which as determined in step 400 of FIG. 9 is only 8. In other words, this embodiment of the preventative step 430 of FIG. 9 is conservative, as overall it prevents the allocation of 12 capacity units whereas the computation of FIG. 9, step 400 suggested prevention of allocation of only 8 capacity units. It is however possible to modify the method of the present invention so as to compensate for links which due to being utilized do not accept their full share of the switch's free capacity, by assigning to at least one link which is less utilized, more than its full share of the switch's free capacity.

The operation of FIG. 14, using Example III, is now described with reference to FIG. 17C. In step 1200, as in steps 900 and 1100 in FIGS. 12 and 13 respectively, the unutilized capacity of each link (line 5 in FIG. 17C) is computed to be the physical capacity (line 2) minus the traffic load parameter (line 4) yielding for links e1 through e4, unutilized capacity values of 2, 8, 10 and 12 units, respectively.

Step 1210 computes the squares of link unutilized capacities (line 5 in FIG. 17C) to be 4, 64, 100 and 144 respectively, and their sum to be 4+64+100+144=312.

Step 1220 computes the ratio between the switch's physical capacity, 80, and the sum of squares computed in step 1210. In the present example, the ratio is: 80/312=0.2564.

Step 1230 computes a normalization factor to be the product of the switch's desired protection level as computed in FIG. 9 step 400, i.e. 0.1, and the ratio computed in step 1220. The normalization factor in the present example is thus 0.1×0.2564=0.02564.

Step 1240 computes, for each link, the ratio between that link's squared unutilized capacity (the square of the value in line 5) and the link's physical capacity (line 2). These ratios in the present example are 4/20=0.2 for e1, 64/20=3.2 for e2, 100/20=5 for e3 and 144/20=7.2 for e4.

Step 1250 computes the desired protection level for each link as a product of the relevant fraction computed in step 1240 and the normalization factor computed in step 1230. In the current example, the desired protection levels for the links, as shown in FIG. 17C, line 6, are: 0.2×0.02564=0.005128 for e1, 3.2×0.02564=0.082 for e2, 5×0.02564=0.128 for e3 and 7.2×0.02564=0.1846 for e4.

In summary, the output of step 430 in FIG. 9, using the method of FIG. 14, is (0.005, 0.082, 0.128, 0.185) for links e1-e4 respectively. Proceeding now to Step 440 of FIG. 9, these values yield, for the links e1 through e4, a new precaution motivated unreservable capacity (FIG. 17C, line 7) of 0.005128×20=0.1, 0.082×20=1.6, 0.128×20=2.6 and 0.1846×20=3.7 units, respectively, computed by multiplying each link's desired protection level (FIG. 17C, line 6) by that link's physical capacity (FIG. 17C, line 2).

FIG. 18 is a simplified flowchart illustration of a traffic engineering method which combines the features of the traffic engineering methods of FIGS. 1 and 8. As described above, the method of FIG. 1 diminishes the free capacity, by locking or by defining a fictitious client, as a function of the actual level of utilization of the network as opposed to the theoretical level of utilization implied by client reservations. The method of FIG. 8 diminishes the free capacity, by locking or by defining a fictitious client, as a function of the total load on the switch as opposed to only as a function of the utilizations of individual links.

The method of FIG. 18 combines the functionalities of FIGS. 1 and 8. Typically, the method of FIG. 18 comprises an initialization step 1310 (corresponding to steps 10 and 310 in FIGS. 1 and 8 respectively), a traffic monitoring step 1320 corresponding step 20 in FIG. 1, a traffic load parameter determination step 1330 corresponding to steps 30 and 320 in FIGS. 1 and 8 respectively, a first free capacity diminishing step 1340 corresponding to steps 100-130 of FIG. 1, and a second capacity diminishing step 1350 corresponding to step 330 of FIG. 8. It is appreciated that either the locking embodiment of FIG. 2A or the fictitious client embodiment of FIG. 2B may be used to implement first free capacity diminishing step 1340. Similarly, either the locking embodiment of FIG. 10A or the fictitious client embodiment of FIG. 10B may be used to implement second free capacity diminishing step 1350.

It is appreciated that the software components of the present invention may, if desired, be implemented in ROM (read-only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather, the scope of the present invention is defined only by the claims that follow:

1. A traffic engineering method for reducing congestion and comprising:
estimating traffic over at least one link, having a defined capacity, between communication network nodes, thereby to determine an occupied portion of the link capacity and a complementary unoccupied portion of the link capacity; and
based on the estimating step, selectably preventing allocation of the occupied portion of the link capacity to at least one capacity requesting client.

2. A method according to claim 1 wherein each link has a defined physical capacity and wherein each link is associated with a list of clients and, for each client, an indication of the slice of the link's capacity allocated thereto, thereby to define a reserved portion of the link's capacity comprising a sum of all capacity slices of the link allocated to clients in the list of clients.

3. A method according to claim 1 wherein said preventing allocation comprises partitioning the occupied portion of the link into at least consumed unreservable capacity and reserved capacity and preventing allocation of the consumed unreservable capacity to at least one requesting client.

4. A method according to claim 3 wherein each link is associated with a list of clients and wherein said step of partitioning comprises adding a fictitious client to the list of clients and indicating that the portion of the link capacity allocated thereto comprises the difference between the occupied portion of the link capacity and the reserved portion of the link capacity.

5. A method according to claim 4 wherein said step of adding is performed only when said difference is positive.

6. A method according to claim 1 wherein said step of estimating traffic comprises directly measuring the traffic.

7. A method according to claim 3 wherein said step of partitioning comprises redefining the link capacity to reflect only capacity reserved to existing clients and the capacity of the unoccupied portion of the link.

8. A method according to claim 1 wherein said estimating and preventing steps are performed periodically.

9. A traffic engineering method for reducing congestion in a communication network including at least one switch connected to a plurality of links, each link having a defined physical capacity including a portion thereof which comprises currently unutilized capacity, the method comprising:
computing an expected traffic load parameter over at least one switch; and
based on the computing step, restricting allocation of at least a portion of the capacity of at least one of the links if the expected traffic load parameter exceeds a threshold.

10. A method according to claim 9 wherein said step of computing expected traffic load parameter comprises estimating the current traffic over at least one switch interconnecting communication network nodes.

11. A method according to claim 10 wherein said step of estimating traffic comprises directly measuring the traffic load over the switch.

12. A method according to claim 10 wherein said step of estimating traffic comprises measuring an indication of traffic over the switch.

13. A method according to claim 12 wherein said indication of traffic comprises packet loss over the switch.

14. A method according to claim 12 wherein said indication of traffic comprises packet delay over the switch.

15. A method according to claim 9 wherein said computing step comprises computing an expected traffic load parameter separately for each link connected to the switch.

16. A method according to claim 9 and also comprising:
estimating traffic load parameter over at least one link between communication network nodes, thereby to determine an occupied portion of the link capacity and a complementary unoccupied portion of the link capacity; and
based on the evaluating step, preventing allocation of the occupied portion of the link capacity to at least one capacity requesting client.

17. A method according to claim 16 and also comprising storing a partitioning of the defined capacity of each link into reserved capacity, consumed unreservable capacity, precaution-motivated unreservable capacity, and reservable capacity.

18. A method according to claim 9 wherein the restricting step comprises computing a desired protection level for the at least one switch, thereby to define a desired amount of precaution motivated unreservable capacity to be provided on the switch.

19. A method according to claim 18 and also comprising providing the desired switch protection level by selecting a desired protection level for each link connected to the at least one switch such that the percentage of each link's currently unutilized capacity which is reservable is uniform over all links.

20. A method according to claim 18 and also comprising providing the desired switch protection level by assigning a uniform protection level for all links connected to the at least one switch, said uniform protection level being equal to the desired switch protection level.

21. A method according to claim 18 and also comprising providing the desired switch protection level by computing precaution motivated unreservable capacities for each link connected to the at least one switch to provide equal amounts of free capacity for each link within at least a subset of the links connected to the at least one switch.

22. A method according to claim 9 wherein said restricting is performed periodically.

23. A method according to claim 9 wherein said restricting allocation comprises marking said portion of the capacity of at least one of the links as precaution motivated unreservable capacity.

24. A method according to claim 16 wherein said step of preventing allocation comprises marking the occupied portion of the link capacity as consumed unreservable capacity.

25. A traffic engineering system for reducing congestion, the system comprising:
a client reservation protocol operative to compare, for each of a plurality of links connected to at least one switch, an indication of the physical capacity of each link to an indication of the sum of capacities of reserved slices of said link, and to allocate a multiplicity of capacity slices to a multiplicity of clients such that for each link, the indication of the sum of capacities of reserved slices does not exceed the indication of the physical capacity; and
a capacity indication modifier operative to alter at least one of the following indications:
an indication of the physical capacity of at least one link; and
an indication of the sum of capacities of reserved slices for at least one link,
to take into account at least one of the following considerations:
for at least one link, an expected discrepancy between the link's actual utilized capacity and the sum of capacities of reserved slices for that link;
for at least one switch, an expected discrepancy between the sum of actual utilized capacities over all links connected to an individual switch, and the capacity of the switch,
thereby to reduce congestion.

26. A method according to claim 18 also comprising providing the desired switch protection level by selecting a desired protection level for each link connected to the at least one switch including turning more of a link's currently unutilized capacity into precaution motivated unreservable capacity for a link having a relatively high unutilized capacity, relative to a link having a relatively low unutilized capacity.

27. A method according to claim 20 and also comprising providing the desired protection level by selecting a desired protection level for each link connected to the at least one switch such that said desired amount of precaution motivated unreservable capacity on the switch is distributed equally among all of the links connected to the switch.

28. A method according to claim 21 and also comprising providing the desired switch protection level by computing precaution motivated unreservable capacities for each link connected to the at least one switch to provide equal amounts of free capacity for all links connected to the at least one switch.

29. A method according to claim 9, wherein said restricting step comprises:
restricting allocation of at least a first portion of the capacity of at least one of the links if the expected traffic load parameter exceeds a first threshold; and
restricting allocation of at least an additional second portion of the capacity of at least one of the links if the expected traffic load parameter exceeds a second threshold which is greater than the first threshold, wherein said additional second portion is greater than the first portion.

30. A traffic engineering method for reducing congestion, the method comprising:
comparing, for each of a plurality of links connected to at least one switch, an indication of the physical capacity of each link to an indication of the sum of capacities of reserved slices of said link, and to allocate a multiplicity of capacity slices to a multiplicity of clients such that for each link, the indication of the sum of capacities of reserved slices does not exceed the indication of the physical capacity; and
altering at least one of the following indications:
an indication of the physical capacity of at least one link; and
an indication of the sum of capacities of reserved slices for at least one link,
to take into account at least one of the following considerations:
for at least one link, an expected discrepancy between the link's actual utilized capacity and the sum of capacities of reserved slices for that link;
for at least one switch, an expected discrepancy between the sum of actual utilized capacities over all links connected to an individual switch, and the capacity of the switch,
thereby to reduce congestion.

31. A traffic engineering system for reducing congestion and comprising:
a traffic estimator estimating traffic over at least one link, having a defined capacity, between communication network nodes, thereby to determine an occupied portion of the link capacity and a complementary unoccupied portion of the link capacity; and
an allocation controller operative, based on output received from the traffic estimator, to selectably prevent allocation of the occupied portion of the link capacity to at least one capacity requesting client.

32. A traffic engineering system for reducing congestion in a communication network including at least one switch connected to a plurality of links, each link having a defined physical capacity including a portion thereof which comprises currently unutilized capacity, the system comprising:
a traffic load computer operative to compute an expected traffic load parameter over at least one switch; and
an allocation restrictor operative, based on an output received from the traffic load computer, to restrict allocation of at least a portion of the capacity of at least one of the links if the expected traffic load parameter exceeds a threshold.
